(19) United States
(12) Patent Application Publication
(10) Pub. No.: US 2007/0082227 A1
(43) Pub. Date: Apr. 12, 2007

(54) Light-emitting device

(76) Inventors: Tsuyoshi Kobayashi, Kawasaki-shi (JP); Satoshi Mikoshiba, Yamato-shi (JP); Tomoko Eguchi, Yokohama-shi (JP); Takashi Kuboki, Tokyo (JP); Takashi Kishi, Yokosuka-shi (JP); Shinji Murai, Sagamihara-shi (JP); Hidesato Saruwatari, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/389,206

(22) Filed: Mar. 27, 2006

(30) Foreign Application Priority Data
Sep. 29, 2005 (JP) 2005-283363

(51) Int. Cl. B32B 19/00; B32B 9/00

(52) U.S. Cl. 428/690

(57) ABSTRACT

A light-emitting device is provided, which includes an insulating substrate, a first electrode and a second electrode insulated from each other and formed above the insulating substrate, and an electrolyte disposed on the first electrode and the second electrode. The electrolyte contains an ionic liquid and luminescent pigment having a reversible redox structure. Each of the first electrode and the second electrode have an elongated configuration, in an unit length of each of the first electrode and the second electrode, a surface area is 3 to 1000 times as large as a ground contact area, the surface area being an area of a surface of each of the first electrode and the ground contact area being an area projected upon the insulating substrate as the insulating substrate provided with the first electrode and the second electrode is looked from a top surface of the insulating substrate.

### CROSS-REFERENCE TO RELATED APPLICATIONS

This application is based upon and claims the benefit of priority from prior Japanese Patent Application No. 2005-283363, filed Sep. 29, 2005, the entire contents of which are incorporated herein by reference.

### BACKGROUND OF THE INVENTION

1. Field of the Invention

This invention relates to a light-emitting device and a method for manufacturing the light-emitting device.

2. Description of the Related Art

As a planer light-emitting device, a solid EL (electroluminescent) device is extensively studied at present. Although it is possible, with this EL device, to obtain high luminance, an electric voltage of not less than 6 V is required for the emission of light. Further, since a process of forming a film by vapor deposition is required in this case, there is a limitation in any attempt to obtain a light-emitting device of large area and moreover such an attempt would lead to an increase of cost in the manufacture of such a light-emitting device.

On the other hand, in the case of a liquid type light-emitting device, although the voltage required for the emission of light can be decreased to 3 V or so, it is required, for the emission of light, to enable oxidant and reductant to move in an electrolyte. Furthermore, the luminance of the liquid type light-emitting device is lower than that of a solid type light-emitting device. Meanwhile, it has been found possible to enhance the luminance of emitted light by introducing a porous layer to the surface of an electrode. The introduction of a porous layer to the surface of an electrode can be performed by an inexpensive step such as coating and printing and, hence, is suited for easily fabricating a light-emitting device of large area as compared with the aforementioned process of forming a film by vapor deposition. Because of these merits, the liquid type light-emitting device is now attracting much attention.

With respect to the light-emitting device where an organic solvent-based electrolyte is employed, there has been proposed, in place of forming the conventional ITO, a technique of employing a tandem electrode which can be formed by sputtering a metal on the surface of insulating body to form a fine metallic electrode. However, since the electric current which can be passed to a cell depends on the area of electrode if a plane electrode is employed, the magnitude of electric current that can be passed to the cell is regulated by the area of the substrate. Further, it is also required in this case to reduce the cost for the process of forming the wirings. Since the luminance of this light-emitting device is still inferior than that of solid type light-emitting device, it is demanded to further enhance the luminance of emission thereof. Further, even in the case of aforementioned device which has been improved in luminance through the introduction of a porous layer to the surface of electrode, there is a problem that the half-life of light intensity thereof is short, i.e. the device life is short.

In the process of manufacturing the electrodes of the conventional light-emitting device, the electrodes are formed by sputtering, etc. When a tandem electrode is created, the electric field to be generated between the electrodes becomes non-uniform. Furthermore, the electric field to be applied to the porous layer that has been formed for promoting the light-emitting reaction among the electrodes becomes also non-uniform. As a result, it is impossible to obtain a high emission of light even if the same magnitude of electric field is applied to the electrodes, resulting in a light-emitting device of low efficiency relative to power consumption. The electrodes are formed wide relative to the thickness thereof so that the cross-section thereof is flat. Due to this configuration, when the wiring is provided at a large ratio in a substrate of large area or in a substrate for a high-intensity light-emitting device, etc., the relative effective area of the electrode portion which does not contribute to the emission of light relative to the current carrying capacity of wiring increases.

### BRIEF SUMMARY OF THE INVENTION

A light-emitting device according to one aspect of the present invention comprises an insulating substrate; a first electrode formed above the insulating substrate and having an elongated configuration, in an unit length of the first electrode, a surface area being 3 to 1000 times as large as a ground contact area, the surface area being an area of a surface of the first electrode and the ground contact area being an area projected upon the insulating substrate as the insulating substrate provided with the first electrode is looked from a top surface of the insulating substrate; a second electrode formed above the insulating substrate, the second electrode being insulated from the first electrode and having an elongated configuration, in an unit length of the second electrode, a surface area being 3 to 1000 times as large as a ground contact area, the surface area being an area of a surface of the second electrode and the ground contact area being an area projected upon the insulating substrate as the insulating substrate provided with the second electrode is looked from a top surface of the insulating substrate; and an electrolyte disposed on the first electrode and the second electrode and containing an ionic liquid as a major component and luminescent pigment having a reversible redox structure.

A method for manufacturing a light-emitting device according to another aspect of the present invention comprises forming a laminated or wound composite containing a first electrode and a second electrode with a spacer being interposed therebetween; forming the first electrode and the second electrode on a first insulating substrate, the first electrode and the second electrode extending in a longitudinal direction and being insulated from each other; removing the spacer; positioning a second insulating substrate to face the first insulating substrate with an insulating outer frame being interposed therebetween, thus leaving a space between the second insulating substrate and the first insulating substrate; injecting an electrolyte containing a molten salt and a colorant into the space through a port; and sealing the port for the electrolyte.

### BRIEF DESCRIPTION OF THE SEVERAL VIEWS OF THE DRAWING

FIG. 1 is a perspective view illustrating a tandem electrode to be employed in a light-emitting device according to one embodiment of the present invention;

FIG. 2 is a cross-sectional view illustrating one step in the method of manufacturing a light-emitting device according to one embodiment of the present invention;

FIG. 3 is a cross-sectional view illustrating a step following the step shown in FIG. 2;

FIG. 4 is a cross-sectional view illustrating a step following the step shown in FIG. 3;

FIG. 5 is a cross-sectional view illustrating a step following the step shown in FIG. 4;

FIG. 6 is a cross-sectional view illustrating a step following the step shown in FIG. 5;

FIG. 7 is a cross-sectional view illustrating a step following the step shown in FIG. 6;

FIG. 8 is a cross-sectional view illustrating a light-emitting device according to another embodiment of the present invention;

FIG. 9 is a cross-sectional view illustrating one step in the method of forming an electrode for a light-emitting device according to another embodiment of the present invention;

FIG. 10 is a cross-sectional view illustrating a step following the step shown in FIG. 9;

FIG. 11 is a cross-sectional view illustrating a step following the step shown in FIG. 10;

FIG. 12 is a cross-sectional view illustrating a step following the step shown in FIG. 11;

FIG. 13 is a cross-sectional view illustrating one step in the method of forming an electrode for a light-emitting device according to a further embodiment of the present invention;

FIG. 14 is a cross-sectional view illustrating a step following the step shown in FIG. 13;

FIG. 15 is a cross-sectional view illustrating a step following the step shown in FIG. 14;

FIG. 16 is a cross-sectional view illustrating a step following the step shown in FIG. 15;

FIG. 17 is a perspective view illustrating one step in the method of forming an electrode for a light-emitting device according to a further embodiment of the present invention;

FIG. 18 is a perspective view illustrating a step following the step shown in FIG. 17;

FIG. 19 is a perspective view illustrating a step following the step shown in FIG. 18;

FIG. 20 is an enlarged cross-sectional view illustrating the details of electrodes;

FIG. 21 is a cross-sectional view illustrating a step following the step shown in FIG. 20;

FIG. 22 is a cross-sectional view illustrating one step in the method of manufacturing a light-emitting device according to a further embodiment of the present invention;

FIG. 23 is a cross-sectional view illustrating a step following the step shown in FIG. 22;

FIG. 24 is a cross-sectional view illustrating one step in the method of forming an electrode for a light-emitting device according to a further embodiment of the present invention;

FIG. 25 is a cross-sectional view illustrating a step following the step shown in FIG. 24;

FIG. 26 is a cross-sectional view illustrating a step following the step shown in FIG. 25;

FIG. 27 is a plan view illustrating an electrode shown in FIG. 26;

FIG. 28 is a cross-sectional view illustrating a step following the step shown in FIG. 26;

FIG. 29 is a cross-sectional view illustrating a step following the step shown in FIG. 28;

FIG. 30 is a cross-sectional view illustrating an electrode for a light-emitting device according to a further embodiment of the present invention;

FIG. 31 is a plan view illustrating an electrode for a light-emitting device according to a further embodiment of the present invention;

FIG. 32 is a cross-sectional view illustrating one step in the method of manufacturing a light-emitting device according to a further embodiment of the present invention;

FIG. 33 is a cross-sectional view illustrating a step following the step shown in FIG. 32;

FIG. 34 is a cross-sectional view illustrating an electrode for a light-emitting device according to a further embodiment of the present invention;

FIG. 35 is a cross-sectional view illustrating a light-emitting device according to a further embodiment of the present invention;

FIG. 36 is a cross-sectional view illustrating one step in the method of manufacturing a light-emitting device according to a further embodiment of the present invention;

FIG. 37 is a cross-sectional view illustrating a step following the step shown in FIG. 36;

FIG. 38 is a cross-sectional view illustrating a step following the step shown in FIG. 37;

FIG. 39 is a cross-sectional view illustrating a step following the step shown in FIG. 38;

FIG. 40 is a cross-sectional view illustrating a step following the step shown in FIG. 39;

FIG. 41 is a cross-sectional view illustrating a step following the step shown in FIG. 40;

FIG. 42 is a cross-sectional view illustrating one step in the method of manufacturing a light-emitting device according to a further embodiment of the present invention;

FIG. 43 is a cross-sectional view illustrating a step following the step shown in FIG. 42;

FIG. 44 is a cross-sectional view illustrating a step following the step shown in FIG. 43;

FIG. 45 is a cross-sectional view illustrating a step following the step shown in FIG. 44;

FIG. 46 is a cross-sectional view illustrating a step following the step shown in FIG. 45;

FIG. 47 is a perspective view illustrating one step in the method of manufacturing a light-emitting device according to a further embodiment of the present invention;

FIG. 48 is a cross-sectional view illustrating an integrated electrode sheet;

FIG. 49 is a side view illustrating a folded electrode sheet;

FIG. 50 is a side view illustrating a pressed electrode sheet;

FIG. 51 is a perspective view illustrating a pressed electrode sheet;

FIG. 52 is a perspective view illustrating an electrode sheet which is bonded to a substrate;

FIG. 53 is a cross-sectional view illustrating one step of manufacturing an electrode sheet;

FIG. 54 is a cross-sectional view illustrating a step following the step shown in FIG. 53;

FIG. 55 is a cross-sectional view illustrating a light-emitting device according to a further embodiment of the present invention;

FIG. 56 is a perspective view illustrating one step in the method of manufacturing a light-emitting device according to a further embodiment of the present invention;

FIG. 57 is a cross-sectional view illustrating a step following the step shown in FIG. 56;

FIG. 58 is a cross-sectional view illustrating a step following the step shown in FIG. 57;

FIG. 59 is a perspective view illustrating groups of electrodes which have been cut off;

FIG. 60 is a perspective view illustrating groups of electrodes which have been bonded to a substrate; and

FIG. 61 is a cross-sectional view illustrating a light-emitting device according to a further embodiment of the present invention.

### DETAILED DESCRIPTION OF THE INVENTION

Next, embodiments of the present invention will be explained in detail as follows.

In the light-emitting device according to one embodiment of the present invention, a first electrode and a second electrode, each elongated in configuration, are disposed on an insulating substrate and insulated from each other. As for the material for the insulating substrate, there is not any restriction and hence the insulating substrate can be formed from a material selected from glass, polypropylene(PP), polyethylene(PE), polycarbonate, epoxy resin, etc.

The first and the second electrodes are respectively elongated in configuration and may be linear or sheet-like. When the first and the second electrodes are linear in configuration, they may be respectively formed into a tandem electrode. When the first and the second electrodes are sheet-like, they may be wound for use. As for the material for the electrodes, it can be optionally selected from conductive materials. For example, it is possible to employ a metal, an insulating material provided, on its surface, with a conductive material, and conductive carbon. Among them, metals are more preferable. In particular, it is more preferable to employ metallic materials excellent in corrosion resistance, such as gold, platinum, silver, stainless steel and tungsten. When metals are employed as an electrode, it would become possible to easily work them and to easily manufacture thin electrodes.

However, in one embodiment of the present invention, a surface area per unit length of the first and the second electrodes is confined to 3 to 1000 times as large as a ground contact area per unit length of the first and the second electrodes. The expression “unit length of electrode” means an optional length in the longitudinal direction of wiring provided on a substrate. The expression “cross-section of electrode” means a plane perpendicular to the longitudinal direction of the wiring. The expression “ground contact area of electrode” means an area projected by the aforementioned unit length of electrode as the substrate provided with the electrode is looked from the top surface of the substrate. For example, when it is assumed that the electrode has a width of 50 μm and the unit length of the electrode is 1 mm, the ground contact area of the electrode can be determined from these values as being 0.05 mm². As for the method of determining the surface area per unit length of electrode, it will be explained hereinafter. Since the lower limit of the ratio of this area to 3, it is now possible to sufficiently enhance the luminance of emission. On the other hand, since the upper limit of the ratio of this area to 1000, it is now possible to avoid any problem such as short circuit due to the inclination of the first and the second electrodes.

The height of each of the first and the second electrodes may be confined to range from 1 μm to 10 mm. If the height of these electrodes is 1 μm or more, it is possible to secure a sufficient magnitude of electrode area to obtain a sufficiently high luminance of emission. On the other hand, if the height of these electrodes is not more than 10 mm, it is possible to easily extract the emission of light at a deep portion of electrode out of the device, thereby making it possible to prevent the deterioration of emission efficiency.

When the height of these electrodes are limited to range of 1 μm to 20 μm, these electrodes can be constituted by an aggregate of fine particles having an average particle diameter ranging from 5 nm to 150 nm. Although the particle diameter of fine particles distributes more or less, the particle diameter of fine particles is expressed in this specification by an average value or average particle diameter thereof. As for the method of measuring the particle diameter of fine particles, it is described in the document “Characterization Technique for Ceramics”, issued by Japan Ceramics Association (written by Lecturing Subcommittee of Ceramics Editorial Committee), wherein ASTM method, planimetric method, cord method, etc. are set forth. Based on these methods, the cross-section of sample is observed by a microscope to measure an average particle diameter of a sufficient number of fine particles appearing in the microscopically observed area, thus determining the average particle diameter thereof. Generally, the average particle diameter is determined by measuring the particle diameter of about 100-200 pieces of particles.

When the average particle diameter of fine particles constituting the porous electrode is confined to 5 nm or more, it is possible to enhance the impregnating properties of electrolyte into the electrodes, leading to the enhancement in luminance of emission. When the average particle diameter of fine particles is confined to not more than 150 nm, it is possible to secure sufficient jointing points among the fine particles, leading to the enhancement of mechanical strength of the electrodes. More preferably, the average particle diameter of the fine particles should be confined within the range of 10 nm to 120 nm.

The electrode where the particles and voids are coexisted therein can be referred to as a porous electrode and the surface area per unit length thereof can be determined by the following process. First of all, the cross-section of the electrode is microscopically observed to measure a total of the border lines of particles contacting with the voids. The total of the border lines thus measured is then multiplied by the unit length in the longitudinal direction to obtain a value which is assumed as representing the surface area per unit length of the porous electrode. When the height of these electrodes is limited to range of 1 μm to 20 μm, the surface area can be increased by making the electrode into a porous structure. As a result, the luminance of emission can be sufficiently enhanced.

This porous electrode having a height ranging from 1 to 20 μm and constituted by an aggregate of fine particles having an average particle diameter ranging from 5 to 150 nm can be formed coating, screen printing or inkjet printing.

When the height of the first and second electrodes is confined to the range of 20 to 200 μm, the electrodes are contacted with an insulating substrate through the bottoms of these electrodes. Further, when the height of the first and second electrodes is confined to the range of 0.1 to 10 mm, the electrodes can be contacted with the insulating substrate through not only the bottoms but also the sidewalls thereof. Since these electrodes are plate-like electrodes, the surface area per unit length thereof can be determined by multiplying the unit length by the border line of the cross-section of electrode which is perpendicular to the longitudinal direction of electrode.

Even if the surface of the electrodes which contacts with the insulating substrate is limited to only the bottom thereof, it is possible to secure a sufficient mechanical strength provided that the height of the electrodes is not more than 200 μm. Therefore, there is no possibility of the electrodes being removed from the substrate. On the other hand, even if the electrodes are bonded to the insulating substrate through not only the bottom thereof but also the sidewalls thereof, it is possible to disregard any influence of the area of electrodes that does not take part in the emission of light provided that the height of the electrodes is not less than 0.1 mm.

Irrespective of the configuration of electrode, i.e., either the porous electrode or the bulky electrode, the calculation of the ratio between the surface area thereof and the ground contact area thereof can be performed by optionally selecting the unit length of electrode. No matter how the unit length is selected, the term of longitudinal direction of electrode is cancelled on the occasion of dividing the surface area thereof by the ground contact area thereof. Therefore, in the case of the porous electrode, the value of how many times the surface area per unit length of electrode is as large as the ground contact area thereof is equivalent to the value that can be obtained as a total of the border line of the space of an optional cross-section of the electrode is divided by the width of the electrode. Likewise, in the case of bulky electrode, the value of how many times the surface area per unit length of electrode is as large as the ground contact area thereof is equivalent to the value that can be obtained as the border line of optional cross-section is divided by the width of the electrode.

The electrode which has a height ranging from 20 to 200 μm and is contacted with the insulating substrate through the bottom thereof can be formed by dry etching method or wet etching method. On the other hand, the electrode having a height ranging from 0.1 to 10 mm and being contacted with the insulating substrate not only through the bottom but also through the sidewalls thereof can be formed by a laminating method or a winding method. This laminating method means a process wherein a plurality of sheet-like electrodes are laminated or a pair of electrodes are folded back-and-forth repeatedly and then cut out as required, thus manufacturing electrodes. Whereas the winding method means a process wherein a pair of sheet-like electrodes for example are laminated at first and then wound spirally and cut out as required, thus manufacturing electrodes. Details of these methods will be discussed hereinafter.

Preferably, a porous layer formed of semiconductor or conductor should be deposited on at least one of the first and second electrodes. As for the semiconductor, it is possible to employ a metal oxide and a metal nitride. More specifically, it is possible to employ oxides of titanium, zirconium, hafnium, strontium, zinc, indium, yttrium, lanthanum, vanadium, niobium, tantalum, chromium, molybdenum, transition metals such as tungsten; perovskite such as SrTiO₃, CaTiO₃, BaTiO₃, MgTiO₃, SrNb₂O₆, etc.; composite oxides of these metals; mixed oxides of these metals; GaN; etc. As for the conductor, it is possible to employ Au, Pt, Ag, Rn, In, Cu, Ni, Cr and Al.

The porous layer can be formed by a screen printing method, an inkjet method, a spray method, a coating method, a spin-coating method and a CVD method. It is possible, through the deposition of this porous layer on the electrode, to promote the redox reaction in the electrolyte and hence to enhance the emission efficiency.

The relationship between the height h of the porous layer and the height H of the first and second electrodes should preferably be regulated by 0.5h<H<10h. When H is made larger than 0.5h, the effect of the porous layer can be sufficiently exhibited. On the other hand, when H is limited to less than 10h, it is obviate any possibility of excessively increasing the distance between the surface of the porous layer and the electrodes. As a result, it is possible to secure a sufficient electric conductivity, thus preventing the deterioration of emission efficiency.

In order to prevent the short-circuit between the first electrode and the second electrode, an insulating porous film may be interposed therebetween. This insulating porous film is required to have not only insulating property but also sufficient porosity not to prevent the moving of luminescent pigments. This porous film may be formed of a porous film or nonwoven fabric of polytetrafluoroethylene (PTFE), PE or PP. Alternatively, this porous film can be formed by depositing insulating inorganic particles such as alumina, silica, etc. on the first and second electrodes.

More specifically, the insulating porous film or nonwoven fabric can be interposed between a pair of electrodes. The porous film made from insulating inorganic particles can be formed for example by a screen printing method, an inkjet method, a spray method, a coating method, a spin-coating method and a CVD method. As for the insulating porous film, it is especially preferable to employ a film of silicon dioxide fine particles.

The electrolyte to be employed in the light-emitting device according to one embodiment of the present invention comprises an ionic liquid as a major component, and luminescent pigment having a reversible redox structure. Preferably, this ionic liquid should be a molten salt having a structure represented by the following general formula (A) and the reversible redox material should be a complex having Ru as a central metal.

Incidentally, the expression “major component” in this specification means that the material is included at the highest content (wt %) among the constituent components. As long as the content is limited to not more than 20 wt %, the electrolyte may contain an organic solvent such as carbonates (e.g., ethylene carbonate and propylene carbonate) which is commonly employed as an electrolyte for a lithium ion secondary battery.

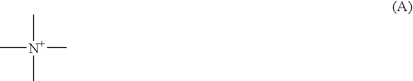

Although there is not any particular limitation with respect to cationic species, it is possible to employ, as cationic species, imidazolium ion, pyridinium ion, quaternary ammonium ion, etc. Among these ions, it is more preferable to employ N,N,N-trimethylbutyl ammonium ion, N-ethyl-N,N-dimethylpropyl ammonium ion, N-(2-methoxyethyl)-N,N-dimethylethyl ammonium ion, 1-ethyl-3-methyl imidazolium ion, 1-ethyl-2,3-dimethyl imidazolium ion, N-methyl-N-propyl pyrrolizinium ion, N-butyl-N-methyl pyrrolizinium ion, N-methyl-N-propyl piperidinium ion, and N-butyl-N-methyl piperidinium ion.

Although there is not any particular limitation with respect to anionic species, it is preferable to employ, as anionic species, PF₆⁻, [PF₃(C₂F₅)₃]⁻, [PF₃(CF₃)₃]⁻, BF₄⁻, [BF₂(CF₃)₂]⁻, [(BF₂(C₂F₅)₂]⁻, [BF₃(CF₃)]⁻, [BF₃(C₂F₅)]⁻, [B(COOCOO)₂⁻](BOB⁻), CF₃SO₃⁻(Tf⁻), C₄F₉SO₃⁻(Nf⁻), [(CF₃SO₂)₂N]⁻ (TFSI⁻), [(C₂F₅SO₂)₂N]⁻ (BETI⁻), [(CF₃SO₂)(C₄F₉SO₂)N]⁻, [(CN)₂N]⁻ (DCA⁻), [(CF₃SO₂)₃C]⁻, and [(CN)₃C]⁻. Among these anion species, it is more preferable to employ BF₄⁻, [BF₃(CF₃)]⁻, [BF₃(C₂F₅)]⁻, (TFSI−) and BETI⁻.

In the light-emitting device according to one embodiment of the present invention, since the surface area per unit length of the electrode is regulated to be 3 to 1000 times as large as the ground contact area per unit length of the electrode, it is now possible to enhance the luminance of emission.

When this electrode is formed of a porous electrode constituted by an aggregate of fine particles, it can be formed by coating, screen printing, or inkjet printing. The electrode can be also formed by a process wherein a film of electrode material is formed at first and then the film is worked into the electrode by dry etching or wet etching.

Alternatively, the electrodes can be manufactured by a laminating method wherein a plurality of sheet-like electrodes are successively laminated, or by winding method wherein a plurality of sheet-like electrodes are spirally wound. More specifically, in the case of laminating method, a plurality of sheet-like electrodes are superimposed one after another with a spacer being interposed between the sheet-like electrodes in order to secure a space between the sheet-like electrodes to manufacture an electrode group. Alternatively, a sheet of spacer is at first sandwiched between a pair of sheet-like electrodes and then this composite is folded back and forth repeatedly to manufacture an electrode group. The electrode group thus obtained may be press-cut as required and the edge portions of the electrodes are fixed with an insulating body. Subsequently, the spacer is removed to manufacture the electrodes. In the case of winding method, a pair of sheet-like electrodes with a sheet of spacer being interposed therebetween are wound to obtain an electrode group, which is then cut as required. After the edge portions of the electrodes are fixed with an insulating body, the spacer is removed to obtain the electrodes.

As for the material for the spacer, there is not any particular limitation as long as it is capable of securing a space between the sheet-like electrodes and it can be removed subsequently, so that it may be formed of conductor, semiconductor or insulator. Specific materials for the spacer include metal, metal oxide, metal salt, inorganic compound and organic polymer. As for the configuration of the spacer, it may be sheet-like, plate-like or mesh-like.

As for configuration of the conductor, it may be metallic foil or metallic mesh. As for configuration of the semiconductor, it may be a metal oxide which is molded into a plate-like body or into a film together with an organic binder. As for configuration of the insulator, it may be a polymer film or a porous polymer film.

In the preparation of the metallic foil or metallic mesh, any kind of metal which can be formed into any of the above-mentioned configuration can be employed. For example, the metallic foil or metallic mesh can be constituted by aluminum, copper, stainless steel, gold and titanium. As of the metal oxide, there is not any particular limitation with regard to the metallic species, so that it is possible to employ aluminum oxide, titanium oxide, zinc oxide and tin oxide. In the case of the metal salt also, there is not any particular limitation with regard to the metallic species and anionic species, so that it is possible to employ aluminum chloride, iron chloride, copper chloride, iron acetate, copper nitrate, etc.

As for the inorganic compound, it is possible to employ various compounds such for example as boric acid, ammonium dihydrogen phosphate, etc. These metal oxide, metal salt and inorganic compound can be singly molded into a plate-like configuration so as to be used as a spacer. Althernatively, These metal oxide, metal salt and inorganic compound may be mixed with a binder and the resultant mixture is molded into a sheet-like configuration so as to be used as a spacer. As for the binder, it is possible to employ an organic polymer such as polyvinylidene difluoride (PVdF) and carbomethoxy cellulose (CMC). As for the polymer film, there is not any particular limitation as long as it is capable of worked into a film-like body, so that it is possible to employ, for example, polyethylene (PE), polypropylene (PP), polyvinyl chloride (PVC), PVdF, polytetrafluoroethylene (PTFE), polytetrafluoroethylene/perfluoroalkylvinylether (PFA), polytetrafluoroethylene/hexafluoropropylene (FEP), polytetrafluoroethylene/ethylene (ETFE), or polyurethane. Further, the polymer film may be a porous structure. As for the polymer film of porous structure, it is possible to employ a polymer film which has been worked into a porous structure or a fibrous polymer such as cellulose which has been formed into a sheet of non-woven fabric.

The removal of the spacer can be performed in any method as long as the electrodes and the insulating body employed for fixing the edge portions of electrodes are not damaged. For example, it is possible to remove the spacer by various methods such as drawing, dissolution, decomposition, and erosion. The drawing is a method wherein the spacer is pulled out of the electrode group. This drawing method can be adopted as long as it is possible to prevent the fracture of spacer or the deformation of electrodes. This method is applicable to the spacers having every kinds of properties, formed of every kinds of materials and having every kind of configurations.

The dissolution method can be adopted as long as there is no possibility of damaging the function of the electrodes and the insulating body employed for fixing the edge portions of electrodes. For example, when the electrodes are formed of gold foil and the spacer is formed of aluminum foil or aluminum mesh, the spacer can be dissolved by using dilute hydrochloric acid. Thereafter, the dissolved spacer can be washed away by using water. Depending on the features of material constituting the spacer, the spacer can be dissolved by various methods.

For example, when the spacer is formed of PVdF, the spacer can be dissolved by using an organic solvent such as NMP (N-methyl-pyrrolidone) and then removed through washing. When the spacer is formed of a PE porous film, the spacer is heated to shrink the porous film, thus making it possible to remove the spacer. Furthermore, when the spacer is formed of a cellulose non-woven fabric, the spacer is permitted to corrode by enzyme and microorganism in water at first and then the spacer is washed away. Occasionally, a film constituted by sodium chloride and CMC is employed as the spacer. This spacer can be manufactured by coating an aqueous solution containing sodium chloride and CMC on one of the surfaces of electrode, the coated layer being subsequently dried to obtain the spacer. Therefore, this spacer can be easily removed. Specifically, when this spacer is washed with water, it can be easily dissolved and removed. Further, when the spacer is formed of a PE film, it can be removed by heating it under air atmosphere or under an atmosphere of oxygen/ozone so as to oxidatively decomposing the spacer.

As for the material for the insulating body to be employed for fixing the edge portions of electrodes, there is not any particular limitation as long as the function thereof cannot be damaged in the step of removing the spacer. For example, it is possible to employ various organic polymers such as PE, PP, PVdF, PTFE and polyurethane. In this case, the spacer should preferably be removed by a suitable method depending on the kinds of material constituting the aforementioned insulating body. For example, when the insulating body is formed of PE or PP, the spacer should preferably be removed by drawing or dissolution method using hydrochloric acid or organic solvent. Further, when the insulating body is formed of PVdF, the spacer should preferably be removed drawing or dissolution method using hydrochloric acid.

Among the various methods of removing-the spacer, the drawing method is most convenient and preferable. The next preferable method is heating method. This heating method is especially effective in the case where the intervals between the electrodes are relatively narrow.

By using any of these methods, the electrodes having desirable properties can be easily fabricated, thus making it possible to manufacture a light-emitting device excellent in emission luminance at low cost.

Next, Examples of the present invention will be explained more detail with reference to drawings.

### EXAMPLE 1

First of all, as shown in FIG. 1, a pair of tandem electrodes 2a, 2b were formed on a first glass substrate 1 having a thickness of 1.1 mm in such a manner that the gap between facing electrodes became 100 μm. The electrodes 2a, 2b in this Example were respectively made of a baked silver electrode and formed by screen printing using a mixture of silver fine particles having an average particle diameter of 500 nm and glass frit, which was dispersed in an organic binder (Dexa Japan Co., Ltd.).

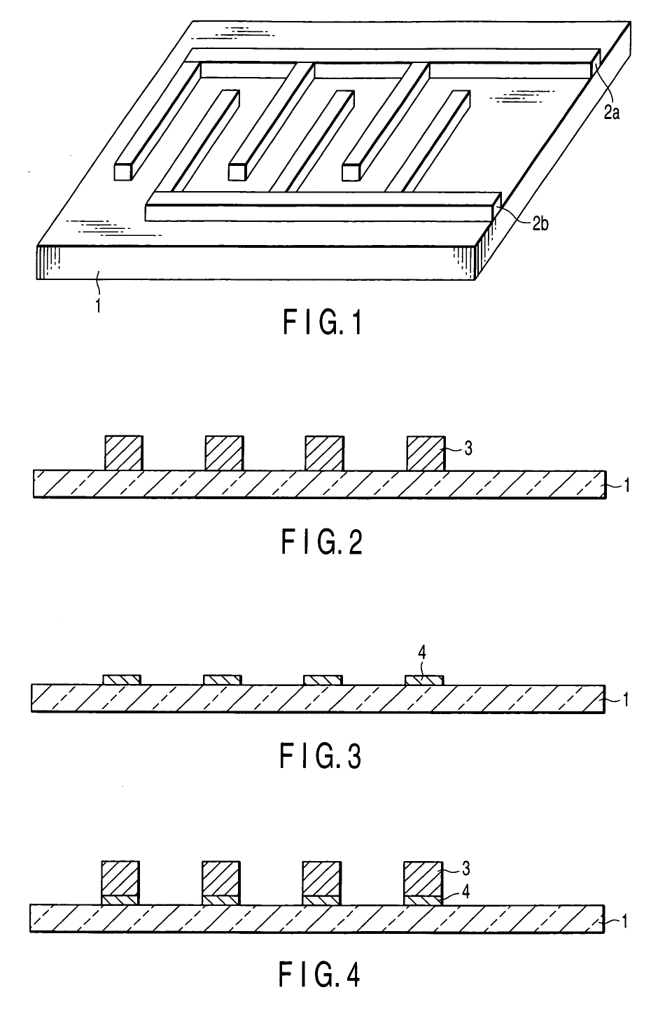

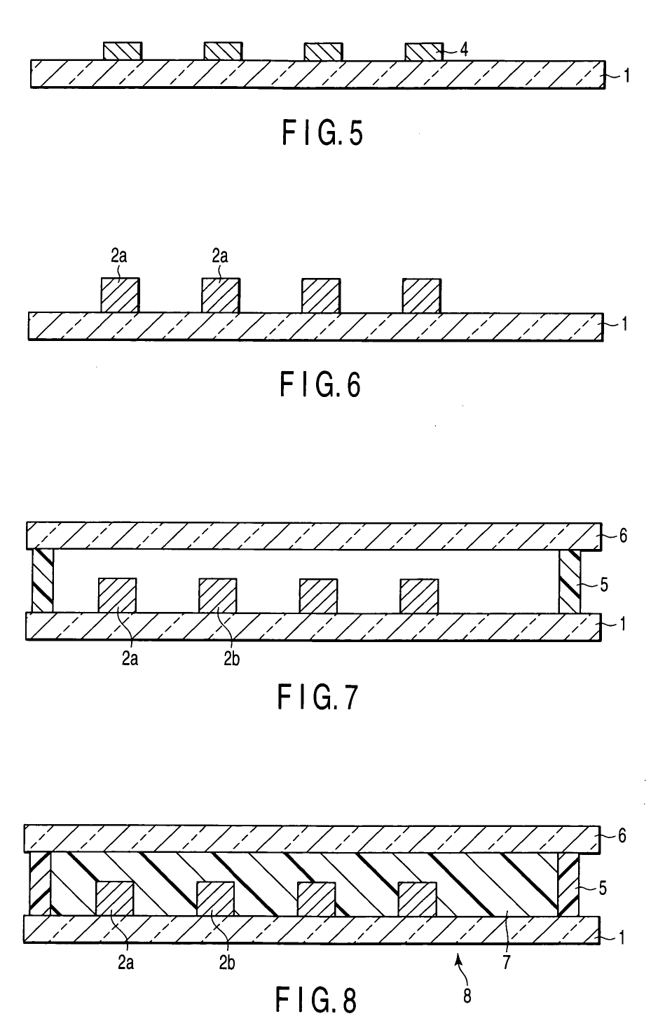

The method of manufacturing the light-emitting device in this Example will be explained with reference to FIGS. 2 to 8. First of all, as shown in FIG. 2, a silver paste 3 was printed on a glass substrate 1. In this printing, a metal mask (20 μm in thickness) having a pattern of gap (18 μm in width) for use in silver paste printing was employed. The printed silver paste was then sintered at a temperature of 550° C. to obtain sintered shrunk silver electrodes 4 as shown in FIG. 3. On these silver electrodes 4, another silver paste 3 was further printed as shown in FIG. 4 and sintered in the same manner as described above to form an integrated silver electrode 4 as shown in FIG. 5. These printing and sintering were repeated until a silver electrode having a predetermined height was obtained, thus obtaining counter electrodes 2a, 2b having a height of 18 μm as shown in FIG. 6. These electrodes 2a, 2b were respectively a bulk electrode having no voids therein and constituted by an aggregate of silver fine particles having an average particle diameter of 500 nm and glass frit.

When a partially cut piece of the substrate 1 was microscopically observed, the height of the electrodes 2a, 2b thus produced was 18 μm which was 1.0 times as large as the width (18 μm) of bottom thereof. Further, the surface area per unit length of these electrodes was about 4.0 times as large as the ground contact area per unit length of these electrodes. The surface area per unit length of the electrodes was determined by a calculation method wherein a total of the border lines between the particle diameter and voids measured through the aforementioned microscopic observation of the cross-section of electrodes was multiplied by the unit length. Likewise, the ground contact area of electrodes was also determined by a method wherein a total of the border lines calculated through the microscopic observation of cross-section of electrodes was multiplied by the unit length. This calculation method was employed also in the following examples and the comparative examples.

Thereafter, as shown in FIG. 7, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 8. Under the condition where one of the counter electrodes 2a, 2b formed on the first glass substrate 1 was made negative with the other being made positive, when an electric current was passed therebetween at a dc voltage of 3 V, light was emitted at a light volume of 280 cd/m².

The measurement of luminance was performed using BM-8 (manufactured by Topkon Co., Ltd.), and the luminance at a central portion, i.e. an area of about 1 mm in diameter, was measured so as to measure the half-life of light intensity. In the following examples also, the measurement of luminance was performed in the same manner as described above.

### EXAMPLE2

First of all, as shown in FIG. 1, a pair of tandem electrodes 2a, 2b were formed on a first glass substrate 1 having a thickness of 1.1 mm in such a manner that the gap between facing electrodes became 40 μm. The electrodes 2a, 2b in this Example were respectively made of a baked silver electrode wherein a mixture of silver fine particles having an average particle diameter of 500 nm and glass frit was dispersed in an organic binder.

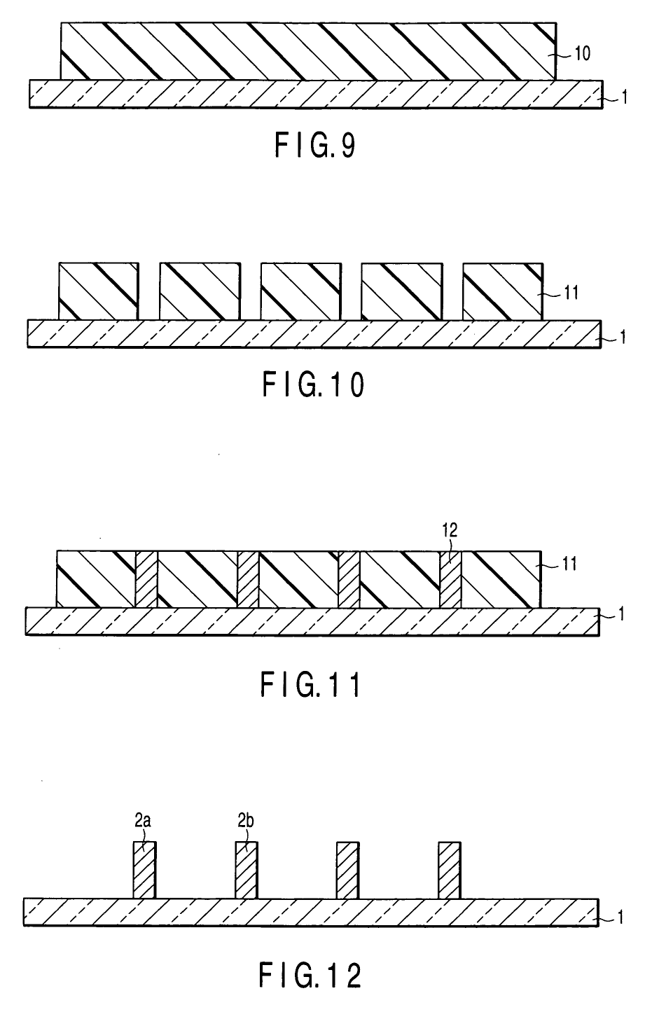

The method of forming the silver electrodes in this Example will be explained with reference to FIGS. 9 to 12. First of all, as shown in FIG. 9, a resist film 10 was formed on a glass substrate 1. Then, the resist film 10 was worked to form a pattern having a gap 3 μm in width, thereby producing a mask formed of a resist pattern 11 as shown in FIG. 10. Then, the gap thus formed was buried with the aforementioned silver paste as shown in FIG. 11 by squeegee printing. The silver paste was then dried and preliminarily cured at a temperature of 150° C. Thereafter, the mask was washed away by using an organic solvent. The residual silver paste was then sintered for 30 minutes at a temperature of 520° C to obtain counter metallic electrodes 2a, 2b having a height of 6 μm as shown in FIG. 12. These electrodes 2a, 2b were respectively a bulk electrode having no voids therein and constituted by an aggregate of silver fine particles having an average particle diameter of 500 nm and fusion-solidified glass.

When a partially cut piece of the substrate 1 was microscopically observed, the height of the electrodes 2a, 2b thus produced was 6 μm which was 2.0 times as large as the width (3 μm) of bottom thereof. Further, the surface area per unit length of these electrodes was about 6.0 times as large as the ground contact area per unit length of these electrodes. The surface area per unit length of the electrodes was determined by the aforementioned measurement and calculation methods using the microscopic observation. The ground contact area was also determined by the aforementioned method where microscopic observation was employed in the measurement.

Thereafter, as shown in FIG. 7, a second glass substrate 6 was disposed to face the first glass substrate 1 through a resin spacer 5 which was positioned, as an outer frame, on the outer circumference of the first glass substrate 1, thereby providing a space of 70 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 8. Under the condition where one of the counter electrodes 2a, 2b formed on the first glass substrate 1 was made negative with the other being made positive, when an electric current was passed therebetween at a dc voltage of 3 V, light was emitted at a light volume of 300 cd/m².

### EXAMPLE3

First of all, as shown in FIG. 1, a pair of tandem electrodes 2a, 2b were formed on a first glass substrate 1 having a thickness of 1.1 mm in such a manner that the gap between facing electrodes became 40 μm. The electrodes 2a, 2b in this Example were respectively formed using copper.

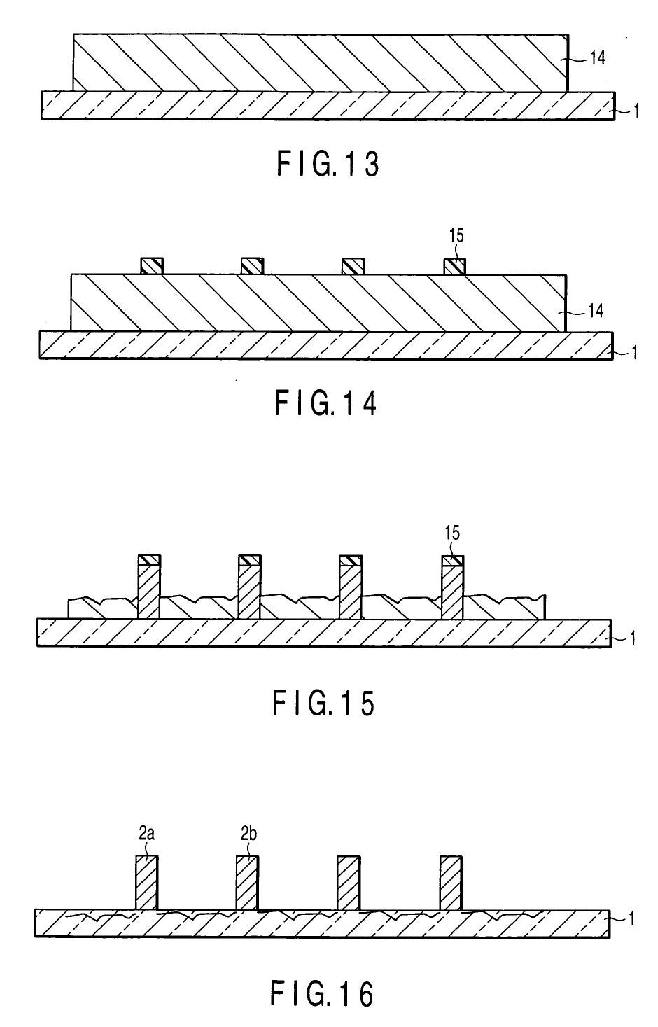

The method of forming the copper electrodes in this Example will be explained with reference to FIGS. 13 to 16. First of all, as shown in FIG. 13, a copper film 14 was formed as an electrode material film on a glass substrate 1 by nonelectrolytic plating to obtain the copper film 14 having a thickness of 17 μm. On this Cu film 14, a mask formed of a resist pattern 15 having a gap 3 μm in width was formed as shown in FIG. 14.

Then, by using a reactive ion etching (RIE) apparatus (ULVAC Co., Ltd.), the Cu film 14 was subjected to etching to selectively remove the Cu film as shown in FIG. 15. The etching in this case was performed in a gas atmosphere of BCl₃ (boron trichloride) or CCl₄ (carbon tetrachloride) under the conditions of: 1-10 Pa, 10-200 SCCM and 400-1000 V in DC bias (V_{dc}). Thereafter, the mask was washed away by using an organic solvent to obtain counter metal electrodes 2a, 2b having a height of 17 μm as shown in FIG. 16.

When a partially cut piece of the substrate 1 was microscopically observed, the height of the electrodes 2a, 2b thus produced was 17 μm which was about 5.4 times as large as the width (3 μm) of bottom thereof. Further, the surface area per unit length of these electrodes was about 12 times as large as the ground contact area per unit length of these electrodes. The surface area per unit length of the electrodes was determined by the aforementioned measurement and calculation methods using the microscopic observation. The ground contact area was also determined by the aforementioned method where microscopic observation was employed in the measurement.

Thereafter, as shown in FIG. 7, a second glass substrate 6 was disposed to face the first glass substrate 1 through a resin spacer 5 which was positioned, as an outer frame, on the outer circumference of the first glass substrate 1, thereby providing a space of 70 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 8. Under the condition where one of the counter electrodes 2a, 2b formed on the first glass substrate 1 was made negative with the other being made positive, when an electric current was passed therebetween at a dc voltage of 3 V, light was emitted at a light volume of 400 cd/m².

### EXAMPLE4

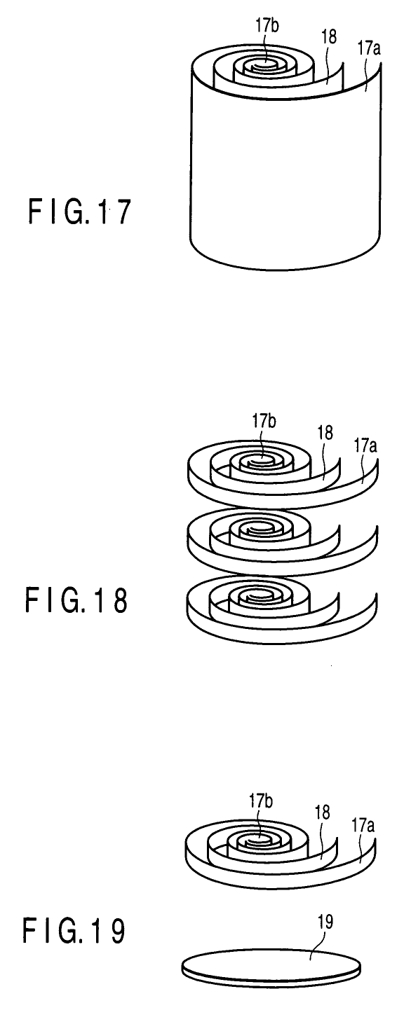

The method of forming the electrodes in this Example will be explained with reference to FIGS. 17 to 19. The method employed in this Example was so-called winding method. First of all, as a plate-like electrode material, a pair of gold foils having a thickness of 100 μm were prepared. As shown in FIG. 17, a PE porous film 18 having a thickness of 20 μm and employed as a spacer was sandwiched between a pair of gold foils 17a, 17b to form a composite, which was then wound spirally to manufacture an electrode group. One end portion of the electrode group thus obtained was cut off using a diamond cutter as shown in FIG. 18 and the cut surface thereof was washed and dried. Thereafter, the cut surface was bonded to the surface of a glass substrate 19 as shown in FIG. 19.

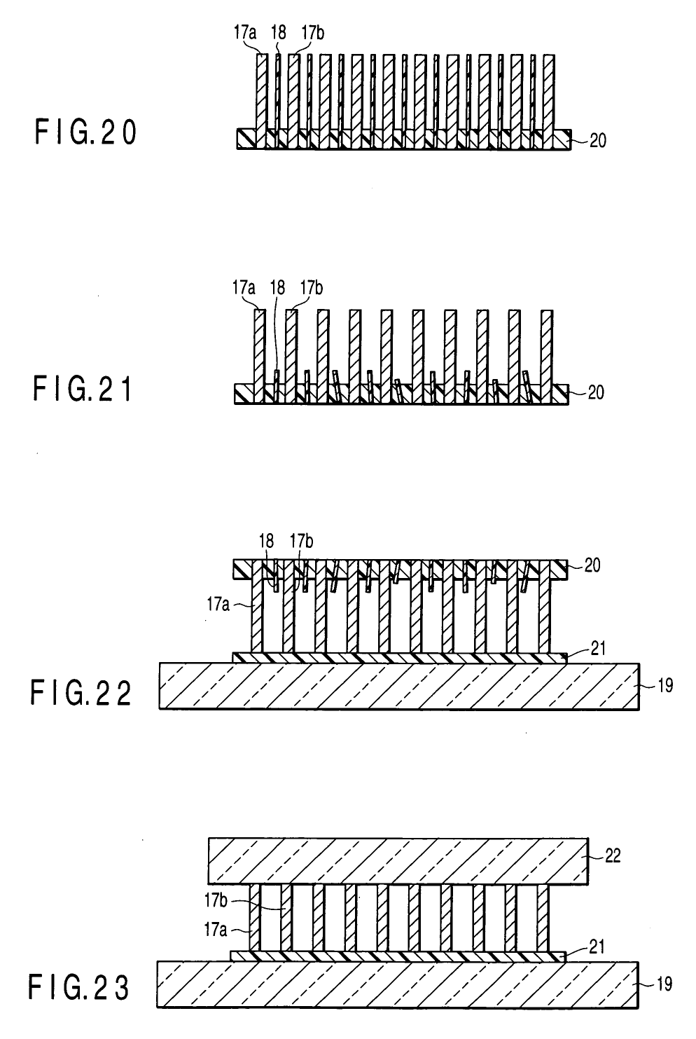

Prior to this bonding, one end portion (1 mm in length from the edge) of the electrode group was fixed together by using epoxy resin 20 as shown in detail in FIG. 20. Then, the electrode group was cut off at a portion thereof located 6 mm away from the aforementioned one end portion thereof to obtain an electrode group wherein a pair of electrodes (15 mm in height) 17a, 17b were spirally arranged on the epoxy resin 20 (1 mm in thickness) with the PE porous film 18 being interposed therebetween. When the electrodes 17a, 17b thus obtained were heated at a temperature of 130° C. for 12 hours, the PE porous film 18 was caused to thermally shrink as shown in FIG. 21.

When a partially cut piece of the substrate 1 was microscopically observed, the height of the electrodes 17a, 17b thus produced was 15 mm which was about 150 times as large as the width (100 μm) of bottom thereof. Further, the surface area per unit length of the electrodes was determined by the aforementioned measurement and calculation methods using the microscopic observation. The ground contact area was also determined by the aforementioned method where microscopic observation was employed in the measurement.

Thereafter, the other end portions (not adhered with the epoxy resin 20) of the counter electrodes 17a, 17b having a height of 1 mm were adhered to glass substrate 19 which was coated in advance with an epoxy adhesive 21 as shown in FIG. 22. The adhesion of the electrodes 17a, 17b to the glass substrate 19 was performed by heat treatment at a temperature of 150° C. for 30 minutes. Thereafter, the epoxy resin 20 having a thickness of 1 mm and the PE layer 18, both located opposite to the aforementioned other end portions of the electrodes 17a, 17b, were cut off to manufacture wound counter electrode layers having a height of 15 mm.

As for the substrate positioned to face the glass substrate 19, a quartz glass 22 was employed and as for the insulating outer frame for separating a pair of substrates 19 and 22 from each other, a polyimide plate (not shown) was employed, thus manufacturing a cell for the light-emitting device as shown in FIG. 23.

On the other hand, 0.2 g of ruthenium (II) trisbipyridyl (PF₆⁻)₂ was dissolved as an emission pigment in 1.1 g of 1-ethyl-3-methylimidazolium hexafluorodimethylsulfone imide employed as a room temperature molten salt, thereby preparing an electrolyte, which was then injected into the space between the pair of electrodes 17a, 17b. Then, the inlet port for electrolyte was sealed according to the conventional method to obtain a light-emitting cell. When an electric current was passed therebetween at an ac voltage of 3 V, light was emitted at a light volume of 300 cd/m².

### Comparative Example 1

A light-emitting device was manufactured by repeating the same procedure as described in Example 1 except that the height of the counter tandem electrodes 2a, 2b was changed to 3.0 μm and the resultant light-emitting device was evaluated in the same manner as described in Example 1. Incidentally, the electrodes 2a, 2b were formed such that the concentration of solvent for the electrode material in screen printing was increased to lower the viscosity of paste, that the thickness of the metal mask was set to 10 μm, and that the number of printing and baking was respectively limited to once.

The height of the electrodes 2a, 2b observed was about 3.0 μm and the surface area per unit length of the electrodes was about 2.3 times as large as the ground contact area per unit length of the electrodes. When the emission of light was tried in the same manner as in Example 1, the light volume thereof was 155 cd/m². Due to the decrease in thickness of the electrodes, the intensity of emission was deteriorated as compared with that of Example 1.

### Comparative Example 2

A light-emitting device was manufactured by repeating the same procedure as described in Example 1 except that a laminate electrode consisting of a Cr layer having a thickness of 50 nm and a Au layer having a thickness of 500 nm was employed as the counter tandem electrodes 2a, 2b and the resultant light-emitting device was evaluated in the same manner as described in Example 1. Incidentally, the electrodes 2a, 2b were formed by sputtering through a metal mask placed on the substrate without changing the gap and the width of electrodes from those of Example 1. The surface area per unit length of the electrodes was about 2.0 times as large as the ground contact area per unit length of the electrodes.

When the emission of light was tried in the same manner as in Example 1, the light volume thereof was 95 cd/m². As in the case of Comparative Example 1, due to the decrease in thickness of the electrodes, the deterioration in intensity of emission was observed.

### Comparative Example 3

A pair of gold foils (15 μm in thickness) 17a, 17b were spirally wound with a PE porous film (20 μm in thickness) being sandwiched therebetween and then worked in the same manner as in Example 4 to manufacture an electrode group. One end portion of the electrode group thus obtained was cut off using a diamond cutter and the cut surface thereof was washed and dried. Thereafter, one end portion (1 mm in length from the edge) of the electrode group was fixed together by using epoxy resin 20. Then, the electrode group was cut off at a portion thereof located 16 mm away from the aforementioned one end portion thereof to obtain an electrode group wherein a pair of electrodes (15 mm in height) 17a, 17b were spirally arranged on the epoxy resin 20 (1 mm in thickness) with the PE porous film 18 being interposed therebetween. When the electrodes 17a, 17b thus obtained were heated at a temperature of 130° C. for 12 hours, the PE porous film 18 was caused to thermally shrink.

When a partially cut piece of the substrate was microscopically observed, the height of the electrodes 17a, 17b thus produced was 15 mm which was about 100 times as large as the width (15 μm) of bottom thereof. The surface area per unit length of the electrodes was about 2000 times as large as the ground contact area per unit length of the electrodes. Further, the surface area and the ground contact area were determined in the same manner as employed in Example 4.

By using quartz glass as counter substrates and by using polyimide plate as a gasket for separating a pair of substrates from each other, the cell of light-emitting device was prepared.

Thereafter, an electrolyte (which was obtained by dissolving 0.2 g of ruthenium (II) trisbipyridyl (PF₆⁻)₂ in 1.1 g of 1 -ethyl-3-methylimidazolium hexafluorodimethylsulfone imide) was then injected into the space between a pair of electrodes 17a, 17b. Then, the inlet port for electrolyte was sealed to obtain a light-emitting cell.

When an ac voltage of 3 V was applied to a pair of facing electrodes to measure the light volume, a trouble of short circuit between the electrodes was recognized in 72 pieces of sample cells out of 97 pieces of sample cells. Further, it was found through the observation using a microscope that there were admitted a large number of defective portions such as the contact between edge portions of electrodes having a length of 15 mm and the fall-down of the electrodes from the root portion thereof. When the light volume of the residual cells was evaluated, the emission of light with a light volume of 100 cd/m² in average was recognized.

### EXAMPLE5

First of all, as shown in FIG. 1, a pair of tandem electrodes 2a, 2b were formed on a first glass substrate 1 having a thickness of 1.1 mm in such a manner that the gap between facing electrodes became 100 μm. The electrodes 2a, 2b in this embodiment were respectively formed using a paste where gold fine particles having an average particle diameter of 50 nm was dispersed therein. More specifically, the paste was applied to the substrate by inkjet method to form a film, which was then baked at a temperature of 500° C. These steps of film-forming and baking were repeated to obtain a porous fine gold particle structure wherein the electrodes 2a, 2b were configured to have a width of 50 μm and a height of 30 μm. Then, a titania paste (Ti-Nanoxide D Solaronics SA (Switzerland)) was coated on these counter electrodes by inkjet method, which was followed by drying and sintering at a temperature of 450° C. for 30 minutes. These coating, drying and sintering steps were repeated five times to obtain the electrodes whose surface was provided with a porous semiconductor layer constituted by a porous titania film having a thickness of 25 μm.

Thereafter, as shown in FIG. 7, a second glass substrate 6 was disposed to face the first glass substrate 1 through a resin spacer 5 which was positioned, as an outer frame, on the outer circumference of the first glass substrate 1, thereby providing a space of 200 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 8. After finishing the measurement of luminance as described above, the sample cell was disintegrated to observe the cross-section of the porous electrode layer. As a result, the surface area was found not less than 600 times as large as the projected area of electrodes to the substrate. Herein, the surface area and the ground contact area were determined in the same manner as described in Example 4.

Then, under the condition where one of the counter electrodes formed on the first glass substrate 1 was made negative with the other being made positive, when an electric current was passed therebetween at a dc voltage of 3 V, light was emitted at a light volume of 350 cd/m². The measurement of luminance was performed using BM-8 (manufactured by TOPCON Corporation (Japan)), and the luminance measured at a central portion, i.e. an area of about 1 mm in diameter, was used to measure the half-life of light intensity.

### EXAMPLE6

First of all, as shown in FIG. 1, a pair of tandem electrodes 2a, 2b were formed on a first glass substrate 1 having a thickness of 1.1 mm in such a manner that the gap between facing electrodes became 100 μm.

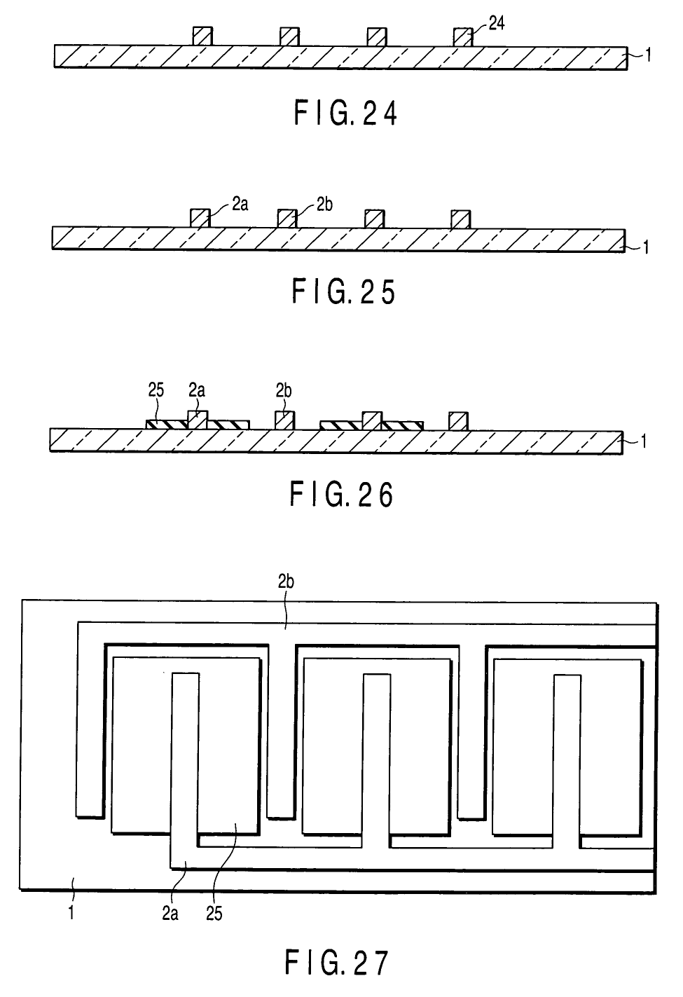

The method of manufacturing the light-emitting device of this Example will be explained with reference to FIGS. 24 to 28. In the preparation of counter electrodes, a paste 24 comprising gold fine particles having an average particle diameter of 150 nm dispersed therein was coated at first on the glass substrate 1 as shown in FIG. 24. The paste thus applied was then baked at a temperature of 500° C. to obtain a pair of counter electrodes 2a, 2b having a porous fine gold particle structure. The electrodes 2a, 2b were configured to have a width of 20 μm and a height of 20 μm. The surface area per unit length of the electrodes 2a, 2b was not less than 220 times as large as the ground contact area per unit length of the electrodes. Further, the surface area and the ground contact area were determined in the same manner as employed in Example 1.

Then, a titania paste (Nanoxide D; Swis Solanics Co., Ltd.) was coated on these counter electrodes by inkjet method, which was followed by drying and sintering at a temperature of 450° C. for 30 minutes. These coating, drying and sintering steps were repeated three times to obtain the electrodes coated thereon with a porous semiconductor layer 25 constituted by a porous titania film having a thickness of 15 μm. The height H of the electrode 2a was about 1.3 times as large as the height h of the porous semiconductor layer 25. FIG. 27 shows a plan view of the glass substrate 1 having the electrode 2a having this porous semiconductor layer 25.

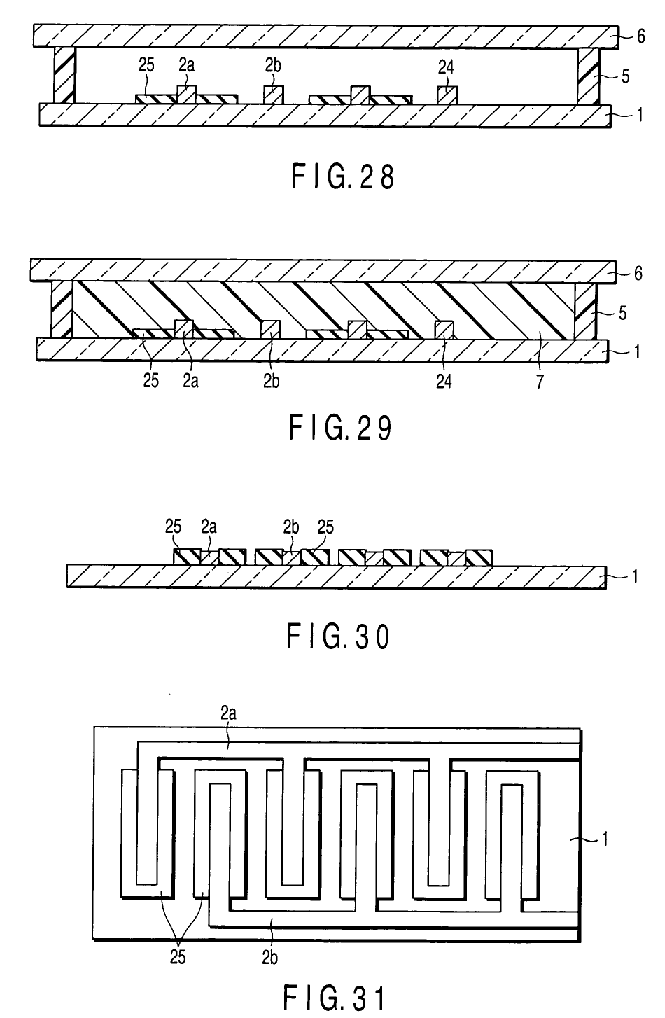

Thereafter, as shown in FIG. 28, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 29. Then, under the condition where one of the counter electrodes formed on the first glass substrate 1 was made negative with the other being made positive, when an electric current was passed therebetween at a dc voltage of 3 V, light was emitted at a light volume of 300 cd/m².

### Comparative Example 4

A pair of tandem electrodes were formed on a first glass substrate having a thickness of 1.1 mm in such a manner that the gap between facing electrodes became 100 μm. The electrodes in this embodiment were respectively formed in a manner that a paste having gold fine particles having an average particle diameter of 5 nm dispersed therein was applied to the substrate and baked at a temperature of 500° C. to form a porous fine gold particle structure. The electrodes thus obtained were configured to have a width of 20 μm and a height of 2 μm.

Then, a titania paste (Nanoxide D; Swis Solanics Co., Ltd.) was coated on these counter electrodes by inkjet method, which was followed by drying and sintering at a temperature of 450° C. for 30 minutes. These coating, drying and sintering steps were repeated three times to obtain the electrodes whose surface was coated with a porous semiconductor layer constituted by a porous titania film having a thickness of 15 μm.

Thereafter, by following the same procedures with respect to the bonding of the second glass substrate, the injection of electrolyte and the sealing of port and by using the kind of electrolyte as those described in aforementioned Example 3, a light-emitting device was obtained. After finishing-the measurement of luminance as described above, the sample cell was disintegrated to observe the cross-section of the porous electrode layer in the same manner as described above. As a result, the surface area per unit length of electrodes was found about 2.3 times as large as the ground contact area per unit length of electrodes.

Then, under the condition where one of the counter electrodes formed on the first glass substrate 1 was made negative with the other being made positive, when an electric current was passed therebetween at a dc voltage of 3 V, light was emitted at a light volume of 95 cd/m². In this comparative example, since the particle diameter of gold particles was too small, the gaps in the electrodes were caused to bury after the sintering of the electrodes. In this structure, it was impossible to obtain a sufficient surface area as a porous electrode. It was assumed that since the electric resistance of electrodes was caused to increase due to insufficient surface area and the porosity of electrodes, the intensity of emission was caused to decrease.

### Comparative Example 5

As for the gold fine particles for the counter electrodes, three kinds of fine particles differing in average particle diameter (500 nm, 50 nm and 5 nm) were mixed together. By following the same process as described in Example 5 excepting that a paste comprising these fine particles dispersed therein was employed, a light-emitting device was manufactured.

After finishing the measurement of luminance as described above, the sample cell was disintegrated to observe the cross-section of the porous electrode layer in the same manner as described above. As a result, the surface area per unit length of electrodes was found not less than 3000 times as large as the projected area of electrodes to the substrate. Then, under the condition where one of the counter electrodes formed on the first glass substrate was made negative with the other being made positive, when an electric current was passed therebetween at a dc voltage of 3 V, light was emitted at a light volume of 115 cd/m².

In this comparative example, since the electrodes were prepared using a mixture of fine particles greatly differing in particle diameter, there were recognized many cases where smaller particles were adhered onto the surface of larger particle. Further, since there was a large difference in average particle diameter among the fine particles, the gaps in the electrodes were caused to increase and the surface area of the electrodes was also caused to greatly increase. It was assumed that because of these facts, the electric resistance of electrodes was caused to increase and the intensity of emission was caused to decrease.

### EXAMPLE7

A titania paste (Nanoxide D; Swis Solanics Co., Ltd.) was coated on the gold foil having a thickness of 50 μm to form a layer having a thickness of 50 μm, which was then dried and sintered at a temperature of 450° C. for 30 minutes. These coating, drying and sintering steps were repeated four times to obtain a porous titania film having a thickness of 20 μm. The opposite surface of the gold foil was also treated in the same manner as described above to obtain a plate-like electrode material having a porous titania film having a thickness of 20 μm on the opposite surfaces thereof.

By using a pair of plate-like electrode materials 17a, 17b thus obtained and a PE porous film 18 (20 μm in thickness), counter electrodes was manufactured as shown in FIGS. 17 to 21. More specifically, as shown in FIG. 17, the PE porous film 18 as a spacer was sandwiched between a pair of the plate-like electrode materials 17a, 17b to form a composite, which was then wound spirally to manufacture an electrode group. One end portion of the electrode group thus obtained was cut off using a diamond cutter as shown in FIG. 18 and the cut surface thereof was washed and dried. Thereafter, one end portion (1 mm in length from the edge) of the electrode group was fixed together by using epoxy resin 20.

Then, the electrode group was cut off at a portion thereof located 6 mm away from the aforementioned one end portion thereof to obtain an electrode group wherein a pair of electrodes (5 mm in height) 17a, 17b were spirally arranged on the epoxy resin 20 (1 mm in thickness) with the PE porous film 18 being interposed therebetween. When the electrodes 17a, 17b thus obtained were heated at a temperature of 130° C. for 12 hours, the PE porous film 18 was caused to thermally shrink, thus accomplishing the counter electrodes having a thickness of 100 μm and a height of 6 mm.

When a partially cut piece of the substrate 1 was microscopically observed, the height of the electrodes 17a, 17b thus produced was 5 mm which was about 100 times as large as the width (50 μm) of bottom thereof. Further, the surface area per unit length of the electrodes was about 200 times as large as the ground contact area per unit length of the electrodes. Herein the surface area and the ground contact area were determined in the same manner as described in Example 4.

As a facing substrate, a quartz glass was employed and as for the insulating outer frame for separating a pair of substrates from each other, a polyimide plate was employed, thus manufacturing a cell for the light-emitting device.

Thereafter, an electrolyte (which was obtained by dissolving 0.2 g of ruthenium (II) trisbipyridyl (PF₆⁻)₂ in 1.1 g of 1-ethyl-3-methylimidazolium hexafluorodimethylsulfone imide) was then injected into the space between a pair of electrodes 17a, 17b . Then, the inlet port for electrolyte was sealed to obtain a light-emitting cell. When an ac voltage of 3 V was applied between the facing electrodes, light was emitted at a light volume of 500 cd/m².

### Comparative Example 6

A pair of plate-like electrode materials 17a, 17b , each provided on opposite surfaces thereof with a porous titania film having a thickness of 20 μm, were manufactured by following the same procedure as described in above Example 7 except the a gold foil having a thickness of 15 μm was employed.

By using a pair of plate-like electrode materials 17a, 17b thus obtained and a PE porous film 18 (20 μm in thickness), counter electrodes was manufactured, wherein the PE porous film 18 was sandwiched as a spacer between a pair of the plate-like electrode materials 17a, 17b . The resultant composite was then wound spirally to manufacture an electrode group. One end portion of the electrode group thus obtained was cut off using a diamond cutter and the cut surface thereof was washed and dried. Thereafter, one end portion (1 mm in length from the edge) of the electrode group was fixed together by using epoxy resin 20.

Then, the electrode group was cut off at a portion thereof located 16 mm away-from the aforementioned one end portion thereof to obtain an electrode group wherein a pair of electrodes (5 mm in height) 17a, 17b were spirally arranged on the epoxy resin 20 (1 mm in thickness) with the PE porous film 18 being interposed therebetween. When the electrodes 17a, 17b thus obtained were heated at a temperature of 130° C. for 12 hours, the PE porous film 18 was caused to thermally shrink.

When a partially cut piece of the substrate was microscopically observed, the height of the electrodes 17a, 17b thus produced was 15 mm which was about 100 times as large as the width (15 μm) of bottom thereof. Further, the surface area per unit length of the electrodes was about 2000 times as large as the ground contact area per unit length of the electrodes. As a facing substrate, a quartz glass was employed and as for the gasket for separating a pair of substrates from each other, a polyimide plate was employed, thus manufacturing a cell for the light-emitting device.

Thereafter, an electrolyte (which was obtained by dissolving 0.2 g of ruthenium (II) trisbipyridyl (PF₆⁻)₂ in 1.1 g of 1-ethyl-3-methylimidazolium hexafluorodimethylsulfone imide) was then injected into the space between a pair of electrodes 17a, 17b . Then, the inlet port for electrolyte was sealed to obtain a light-emitting cell.

When an ac voltage of 3 V was applied to a pair of facing electrodes 17a, 17b to measure the light volume, a trouble of short circuit between the electrodes was recognized in 72 pieces of sample cells out of 97 pieces of sample cells. Further, it was found through the observation using a microscope that there were admitted a large number of defective portions such as the contact between edge portions of electrodes having a length of 15 mm and the fall-down of the electrodes from the root portion thereof. When the light volume of the residual cells was evaluated, the emission of light with a light volume of 110 cd/m² in average was recognized.

In this comparative example, since the height of the electrodes was too large relative to the width thereof, the fall-down or short-circuit of electrodes was permitted to generate to a great degree. Even in the samples which were capable of emitting a measurable intensity of emission without causing short-circuit, the light that had been emitted through a light-emitting reaction occurred in the vicinity of the substrate of electrodes, i.e. at a deep portion of the electrodes as seen from the light-extracting side, was caused to deteriorate in intensity due to the reflection and scattering of light before the light could reach the surface of the device. Therefore, it was assumed that even when the light-emitting device was driven with the same degree of electric power, the intensity of emission was caused to deteriorate in spite of fact that the surface area was increased.

### EXAMPLE8

First of all, as shown in FIG. 1, a pair of tandem electrodes 2a, 2b were formed on a first glass substrate 1 having a thickness of 1.1 mm in such a manner that the gap between facing electrodes became 100 μm. The electrodes 2a, 2b in this Example were respectively made of a baked silver electrode (Dexa Japan Co., Ltd.) and formed by screen printing as shown in FIGS. 2 to 6. Counter metal electrodes having a height of 20 μm were formed by using a metal mask (20 μm in thickness) having a pattern of gap (20 μm in width) for use in paste printing and by repeating the printing and baking at 550° C. 3-5 times. These counter electrodes 2a, 2b thus obtained were respectively a bulk electrode having no voids therein and constituted by an aggregate of silver fine particles having an average particle diameter of 500 nm and glass frit.

When a partially cut piece of the substrate 1 was microscopically observed, the height of the electrodes 2a, 2b thus produced was 20 μm which was 1.0 times as large as the width (20 μm) of bottom thereof. Further, the surface area per unit length of these electrodes was about 4.0 times as large as the ground contact area per unit length of these electrodes. The surface area and the ground contact area were determined in the same manner as described in Example 1.

Then, a titania paste (Nanoxide D; Swis Solanics Co., Ltd.) was coated on the gaps of these counter electrodes 2a, 2b , which was followed by drying and sintering at a temperature of 450° C. for 30 minutes. These coating, drying and sintering steps were repeated three times to form a porous titania film 25 having a thickness of 20 μm as shown in FIG. 30. FIG. 31 shows a plan view of the electrodes thus obtained. As shown in FIG. 31, the porous titania film 25 was disposed on each of the counter electrodes while preventing the porous titania layers from being contacted with each other. Namely, the titania film 25 was constructed as a porous semiconductor layer such that the insulation between the titania layers and between the electrodes could be secured. The height H of the electrodes 2a, 2b was 1.0 times as large as the height h of the porous titania film 25, i.e. a porous semiconductor layer.

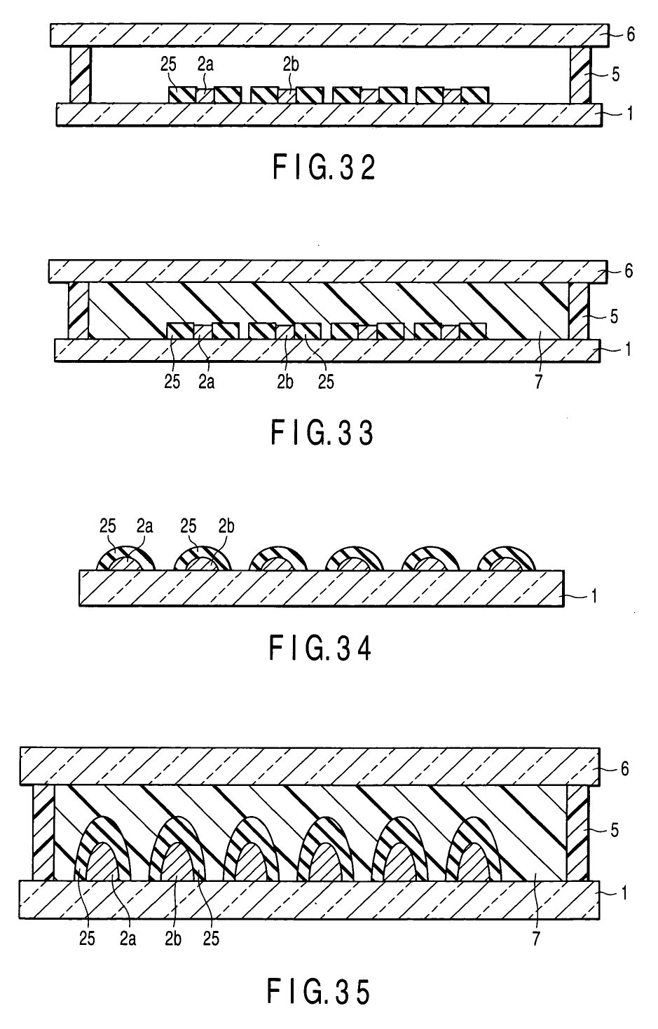

Thereafter, as shown in FIG. 32, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 33. Then, under the condition where one of the counter electrodes formed on the first glass substrate 1 was made negative with the other being made positive, when an electric current was passed therebetween at a dc voltage of 3 V, light was emitted at a light volume of 560 cd/m².

In the light-emitting device according to this Example, it was composed of bulk silver electrodes 2a, 2b which was not porous and relatively low in electric resistance, and the porous titania film 25 or a porous semiconductor layer which was capable of promoting the light-emitting reaction. If the porous titania film 25 is not existed, it may become possible in some case to increase in intensity of emission as the surface area of the electrodes is increased even though it may depend on the demerit that may be caused by an increase of electric resistance due to the porosity of the electrodes 2a, 2b . On the other hand, in the case where the electrodes are bulk electrodes as in the case of this Example, the presence of the porous semiconductor layer which capable of promoting the light-emitting reaction contributes, to a great extent, to the increase in intensity of emission. In this case, a bulk electrode which is advantageous in lowering the electric resistance is suited for use also in the electrodes. Therefore, it was assumed possible in this Example to enhance the intensity of emission as compared with the cases where other kinds of porous electrodes were employed or where the porous semiconductor layer was not provided.

Incidentally, the cross-section of the counter electrodes 2a, 2b may be semi-circular and the porous semiconductor layer 25 may be disposed so as to cover these electrodes as shown in FIG. 34. In this case, the second glass substrate 6 may be disposed through the resin spacer 5 employed as an insulating outer frame as shown in FIG. 35, and then, the electrolyte 7 may be injected into a space between a pair of the glass substrates, thus obtaining a light-emitting device.

### EXAMPLE9

A light-emitting device was manufactured by repeating the same procedures as described in Example 5 excepting that carbon nanoparticles (15 nm in average particle diameter) available in the market were substituted for the silver nanoparticles for forming the porous electrodes and that the temperature for baking was set to 300° C.

First of all, as shown in FIG. 1, a pair of tandem electrodes 2a, 2b were formed on a first glass substrate 1 having a thickness of 1.1 mm in such a manner that the gap between facing electrodes became 100 μm. The electrodes 2a, 2b in this Example were respectively made from a paste wherein carbon nanoparticles having an average particle diameter of 15 nm was dispersed in an organic binder and formed by screen printing as shown in FIGS. 2 to 6. In this screen printing, a metal mask (20 μm in thickness) having a pattern of gap (20 μm in width) for use in paste printing was employed. The printing and baking at 550° C. were repeated 3-5 times to form the counter metal electrodes 2a, 2b having a height of 20 μm. These metal electrodes 2a, 2b thus obtained were respectively formed of a porous electrode constituted by an aggregate of carbon nanoparticles having an average particle diameter of 15 nm.

When a partially cut piece of the substrate 1 was microscopically observed, the height of the electrodes 2a, 2b thus produced was 20 μm which was 1.0 times as large as the width (20 μm) of bottom thereof. Further, the surface area per unit length of these electrodes was about 200 times as large as the ground contact area per unit length of these electrodes. The surface area and the ground contact area were determined in the same manner as described in Example 1.

On the gap formed between these counter electrodes, a porous carbon film was deposited as a porous semiconductor layer. In the formation of this porous semiconductor layer, a paste comprising carbon nanoparticles having a particle diameter of 20 nm dispersed in an organic binder was coated at first. After being dried, the coated layer was baked for 30 minutes at a temperature of 300° C. These coating, drying and sintering steps were repeated three times to form a porous carbon film having a thickness of 20 μm. The height H of the electrodes was 1.0 times as large as the height h of the porous carbon film, i.e. a porous semiconductor layer.

Thereafter, a second glass substrate was disposed to face the first glass substrate through a resin spacer which was positioned, as an outer frame, on the outer circumference of the first glass substrate, thereby providing a space of 100 μm between the first glass substrate and the second glass substrate. An electrolyte prepared by dissolving 0.2 g of ruthenium (II) trisbipyridyl (PF₆⁻)₂ employed as an emission pigment in 1.1 g of 1-ethyl-3-methylimidazolium bis (trifluoromethylsulfonyl) imide employed as a room temperature molten salt was employed.

After this electrolyte was injected into the space between the first glass substrate and the second glass substrate through an inlet port, the inlet port was sealed with epoxy resin to obtain a light-emitting device. Then, under the condition where one of the counter electrodes formed on the first glass substrate was made negative with the other being made positive, when an electric current was passed therebetween at a dc voltage of 3 V, light was emitted at a light volume of 300 cd/m².

### EXAMPLE10

First of all, as shown in FIG. 1, a pair of tandem electrodes 2a, 2b were formed on a first glass substrate 1 having a thickness of 1.0 mm in such a manner that the gap between facing electrodes became 150 μm. The electrodes 2a, 2b in this Example were respectively made of a baked silver electrode (Showa Denko Co., Ltd.) where a mixture comprising silver fine particles having an average particle diameter of 500 nm and glass frit was dispersed in an organic binder and were formed by screen printing as shown in FIGS. 2 to 6. In this printing, a metal mask (30 μm in thickness) having a pattern of gap (30 μm in width) for use in paste printing was employed. The printing of paste and the baking at 520° C. were repeated 3-5 times to form counter metal electrodes 2a, 2b having a height of 30 μm. These counter electrodes 2a, 2b thus obtained were respectively a bulk electrode having no voids therein and constituted by an aggregate of silver fine particles having an average particle diameter of 500 nm and fusion-solidified glass frit.

When a partially cut piece of the substrate 1 was microscopically observed, the height of the electrodes 2a, 2b thus produced was 30 μm which was about 1.4 times as large as the width (22 μm) of bottom thereof. Further, the surface area per unit length of these electrodes was about 4.7 times as large as the ground contact area per unit length of these electrodes. The surface area and the ground contact area were determined in the same manner as described in Example 1.

Then, a titania paste (Nanoxide D; Swis Solanics Co., Ltd.) was coated on the gaps of these counter electrodes 2a, 2b , which was followed by drying and sintering at a temperature of 450° C. for 30 minutes. These coating, drying and sintering steps were repeated four times to form a porous semiconductor layer 25 constituted by a porous titania film having a thickness of 25 μm as shown in FIG. 30. The height H of the electrodes was 1.2 times as large as the height h of the porous titania film, i.e. a porous semiconductor layer.

Thereafter, as shown in FIG. 32, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin to obtain a light-emitting device. Then, under the condition where one of the counter electrodes 2a, 2b formed on the first glass substrate 1 was made negative with the other being made positive, when an electric current was passed therebetween at a dc voltage of 3 V, light was emitted at a light volume of 480 cd/m².

### EXAMPLE11

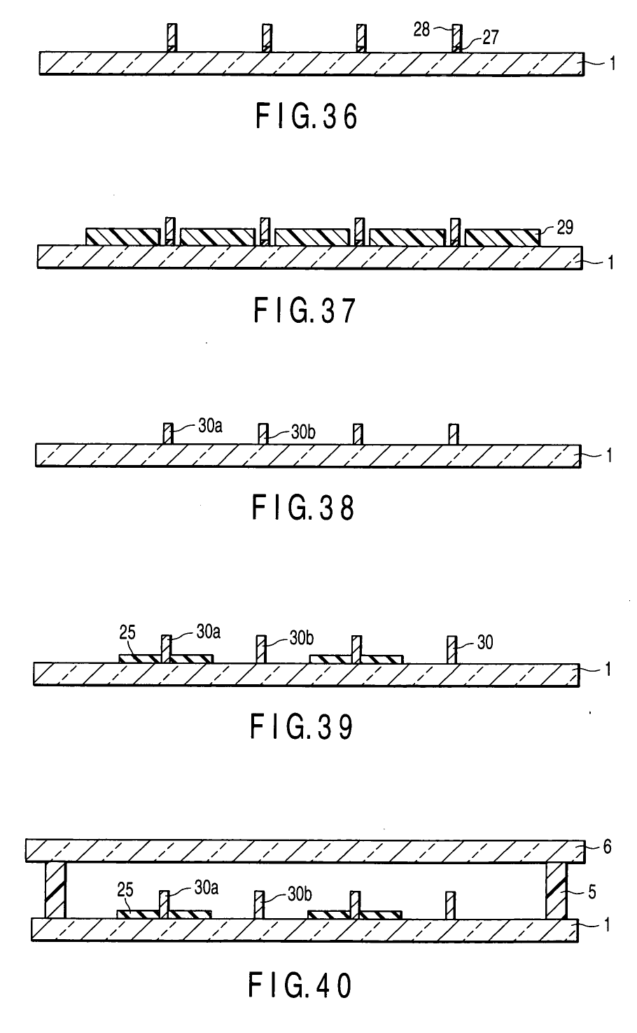

The method of manufacturing the light-emitting device of this Example will be explained with reference to FIGS. 36 to 41.

First of all, as shown in FIG. 36, a gold wire 28 was disposed through a resin film 27 on a glass substrate 1 having a thickness of 1.0 mm at intervals of 150 μm. Then, by using a planar pressing machine, the gold wire 28 was press-bonded onto the substrate 1 by applying a pressure of 5 kg/cm at a temperature of 300° C. In order to prevent the fall-down of the wire during the pressing step, a spacer 29 which was slightly lower than the height of the wire was interposed between the wires as shown in FIG. 37. After finishing the pressing step, the spacer 29 was removed to obtain counter metal electrodes 30a, 30b having a thickness of 200 μm as shown in FIG. 38.

When a partially cut piece of the substrate was microscopically observed, the height of the electrodes 30a, 30b thus produced was 200 μm which was about 6.7 times as large as the width (30 μm)of bottom thereof. Further, the surface area per unit length of these electrodes was about 15.3 times as large as the ground contact area per unit length of these electrodes. The surface area and the ground contact area were determined in the same manner as described in Example 1.

Then, a titania paste (Nanoxide D; Swis Solanics Co., Ltd.) was spray-coated on the gaps of these counter electrodes, which was followed by drying and sintering at a temperature of 450° C. for 30 minutes. These coating, drying and sintering steps were repeated four times to form a porous semiconductor layer 25 constituted by a porous titania film having a thickness of 25 μm as shown in FIG. 39. It was found through the observation of the cross-section of the substrate that the height H of the electrode 30a was about 8 times as large as the height h of the porous titania film, i.e. a porous semiconductor layer 25.

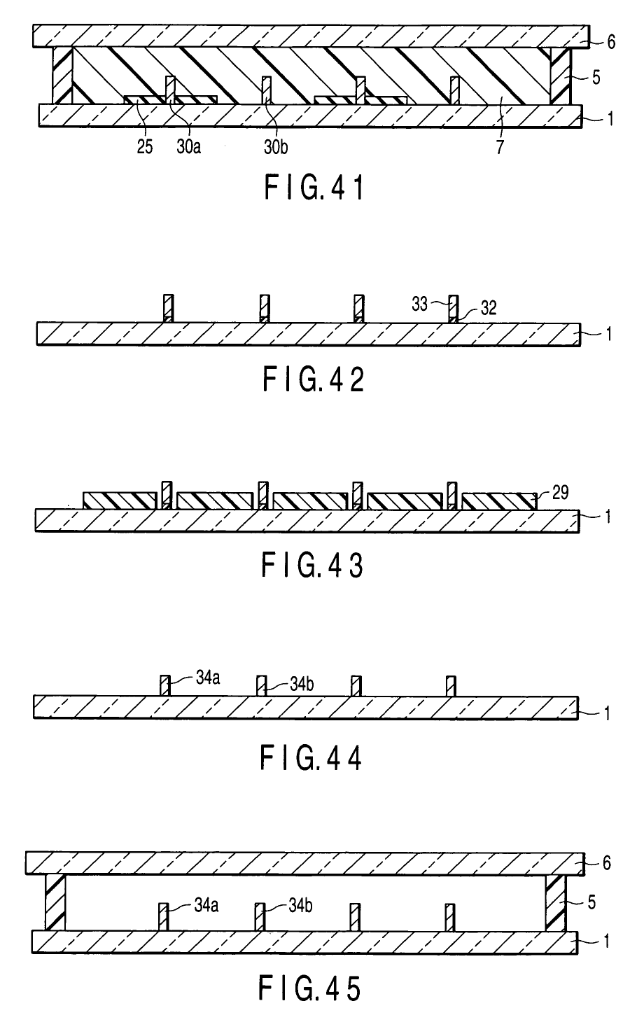

Thereafter, as shown in FIG. 40, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between a pair of glass substrates.

The inlet port for electrolyte was sealed with epoxy resin (not shown) to obtain a light-emitting device as shown in FIG. 41. Then, under the condition where one of the counter electrodes 30a, 30b formed on the first glass substrate 1 was made negative with the other being made positive, when an electric current was passed therebetween at a dc voltage of 3 V, light was emitted at a light volume of 410 cd/m².

In this Example, the height of the electrode 30a was larger than the height of the porous semiconductor layer 25 made of titania. As a result, it was assumed that the electric field to be generated between the electrodes 30a and 30b was enabled to become uniform to the titania layer which was capable of contributing the enhancement of light emission reaction.

### EXAMPLE12

First of all, as shown in FIG. 1, a pair of tandem electrodes 2a, 2b were formed on a first glass substrate 1 having a thickness of 1.1 mm in such a manner that the gap between facing electrodes became 100 μm. The electrodes 2a, 2b in this embodiment were respectively made of a baked silver electrode (Dexa Japan Co., Ltd.) where a mixture comprising silver fine particles having an average particle diameter of 500 nm and glass frit was dispersed in an organic binder and were formed by screen printing as shown in FIGS. 2 to 6. In this printing, a metal mask (20 μm in thickness) having a pattern of gap (30 μm in width) for use in paste printing was employed. The printing of paste and the baking at 550° C. were repeated 6-9 times to form counter metal electrodes 2a, 2b having a height of 30 μm These counter electrodes 2a, 2b thus obtained were respectively a bulk electrode having no voids therein and constituted by an aggregate of silver fine particles having an average particle diameter of 500 nm and fusion-solidified glass frit.

When a partially cut piece of the substrate 1 was microscopically observed, the height of the electrodes 2a, 2b thus produced was 30 μm which was about 1.0 times as large as the width (30 μm) of bottom thereof. Further, the surface area per unit length of these electrodes was about 4.0 times as large as the ground contact area per unit length of these electrodes. The surface area and the ground contact area were determined in the same manner as described in Example 1.

Thereafter, as shown in FIG. 7, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between the first glass substrate 1 and the second glass substrate 6.

The inlet port for electrolyte was sealed with epoxy resin (not shown) to obtain a light-emitting device as shown in FIG. 8. Then, under the condition where one of the counter electrodes 2a, 2b formed on the first glass substrate 1 was made negative with the other being made positive, when an electric current was passed therebetween at a dc voltage of 3 V, light was emitted at a light volume of 450 cd/m².

### EXAMPLE13

The method of manufacturing the light-emitting device of this Example will be explained with reference to FIGS. 42 to 46.

First of all, as shown in FIG. 42, an epoxy adhesive was coated on a first glass substrate 1 having a thickness of 1.0 mm to form a thin layer of epoxy resin and then a gold ribbon 33 having a rectangular cross-section was disposed through a resin film 32 on the thin layer of epoxy resin at intervals of 150 μm. Then, by using a planar pressing machine, the gold ribbon 33 was press-bonded onto the substrate 1 by applying a pressure of 5 kg/cm at a temperature of 300° C. In order to prevent the fall-down of the ribbon during the pressing step, a Teflon block spacer 29 which was dissociative to the epoxy adhesive and slightly lower than the height of the ribbon was interposed between the ribbons as shown in FIG. 43. After finishing the pressing step, the spacer 29 was removed and washed in an organic solvent to remove the epoxy adhesive existing at regions other than the adhered portion between the gold ribbon 33 and the substrate 1. As a result, counter metal electrodes 34a, 34b having a thickness of 180 μm were obtained as shown in FIG. 44.

When a partially cut piece of the substrate was microscopically observed, the height of the electrodes 34a, 34b thus produced was 180 μm which was about 6.0 times as large as the width (30 μm) of bottom thereof. Further, the surface area per unit length of these electrodes was about 14 times as large as the ground contact area per unit length of these electrodes. The surface area and the ground contact area were determined in the same manner as described in Example 10.

Thereafter, as shown in FIG. 45, a second glass substrate 6 was disposed to face the first glass substrate 1 through a resin spacer 5 which was positioned, as an outer frame, on the outer circumference of the first glass substrate 1, thereby providing a space of 100 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between a pair of glass substrates.

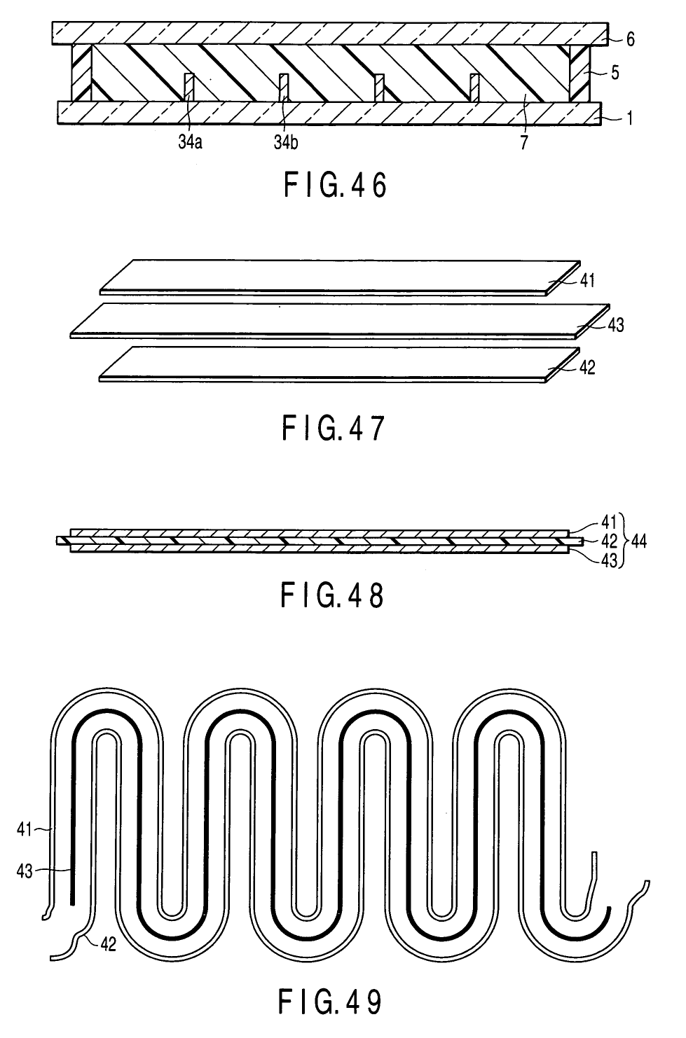

The inlet port for electrolyte was sealed with epoxy resin (not shown) to obtain a light-emitting device as shown in FIG. 46. Then, under the condition where one of the counter electrodes 34a, 34b formed on the first glass substrate 1 was made negative with the other being made positive, when an electric current was passed therebetween at a dc voltage of 3 V, light was emitted at a light volume of 410 cd/m².

### EXAMPLE14

As shown in FIG. 44, a pair of tandem electrodes 34a, 34b were formed on a first glass substrate 1 having a thickness of 1.0 mm in such a manner that the gap between facing electrodes became 150 μm. The counter electrodes 34a, 34b in this case were formed as follows. Namely, a gold ribbon 33 having a rectangular cross-section having a width of 180 μm and a thickness of 30 μm was arranged side by side on the glass substrate having a thin layer of epoxy adhesive as shown in FIG. 42. Then, by using a planar pressing machine, the gold ribbon 33 was press-bonded onto the glass substrate 1 by applying a pressure of 5 kg/cm at a temperature of 300° C. In order to prevent the fall-down of the ribbon during the pressing step, a Teflon block spacer 29 which was dissociative to the epoxy adhesive and slightly lower than the height of the ribbon was interposed between the ribbons as shown in FIG. 43. After finishing the pressing step, the spacer 29 was removed.

Thereafter, a small quantity of epoxy resin was injected into the gaps between the counter electrodes 34a, 34b and cured at a temperature of 150° C. for 30 minutes, thereby forming a structure where lower ends of the counter electrodes were buried in the epoxy resin at a depth of 20 μm. Incidentally, the term “buried” herein means that a portion of each of the electrodes 34a, 34b is buried in the substrate 1 so that the contact portion between the substrate and the electrodes includes not only the bottom of the electrode but also a portion of sidewalls thereof. Namely, three planes of the electrode including the bottom and the opposite sides thereof are enabled to contact with the substrate and there is a sidewall portion which is prevented from being contacted with an electrolyte.

In this manner, it was possible to fabricate counter metal electrodes 34a, 34b having a height of 160 μm on the first substrate 1 constituted by glass and epoxy resin as shown in FIG. 44. When a partially cut piece of the substrate was microscopically observed, the height of the electrodes 34a, 34b thus produced was 160 μm which was about 5.2 times as large as the width (30 μm) of bottom thereof. Further, the surface area per unit length of these electrodes was about 14 times as large as the ground contact area per unit length of these electrodes. The surface area and the ground contact area were determined in the same manner as described in Example 10.

Thereafter, as shown in FIG. 45, a second glass substrate 6 was disposed to face the first glass substrate 1 through a resin spacer 5 which was positioned, as an outer frame, on the outer circumference of the first glass substrate 1, thereby providing a space of 300 μm between the first glass substrate 1 and the second glass substrate 6. On the other hand, 0.2 g of ruthenium (II) trisbipyridyl (PF₆⁻)₂ was dissolved as an emission pigment in 1.1 g of 1-ethyl-3-methylimidazolium bis (trifluoromethylsulfonyl) imide employed as a room temperature molten salt, thereby preparing an electrolyte 7, which was then injected into the space between a pair of glass substrates.

The inlet port for electrolyte was sealed with epoxy resin (not shown) to obtain a light-emitting device as shown in FIG. 46. Then, under the condition where one of the counter electrodes 34a, 34b formed on the first glass substrate 1 was made negative with the other being made positive, when an electric current was passed therebetween at a dc voltage of 3 V, light was emitted at a light volume of 440 cd/m².

### EXAMPLE15

By using a pair of gold foils 17a, 17b having a thickness of 50 μm and a PE porous film 18 having a thickness of 20 μm and by following the steps shown in FIGS. 17 to 21, counter electrodes were formed. More specifically, as shown in FIG. 17, the PE porous film 18 was sandwiched between a pair of the gold foils 17a, 17b to form a composite, which was then wound spirally to manufacture an electrode group. One end portion of the electrode group thus obtained was cut off using a diamond cutter as shown in FIG. 18 and the cut surface thereof was washed and dried. Thereafter, one end portion (1 mm in length from the edge) of the electrode group was fixed together by using epoxy resin 20.

Then, the electrode group was cut off at a portion thereof located 6 mm away from the aforementioned one end portion thereof to obtain an electrode group wherein a pair of electrodes (5 mm in height) 17a, 17b were spirally arranged on the epoxy resin 20 (1 mm in thickness) with the PE porous film 18 being interposed therebetween. When the electrodes 17a, 17b thus obtained were heated at a temperature of 130° C. for 12 hours, the PE porous film 18 was caused to thermally shrink to accomplish the electrodes.

When a partially cut piece of the substrate 1 was microscopically observed, the height of the electrodes 17a, 17b thus produced was 5 mm which was about 100 times as large as the width (50 μm) of bottom thereof. Further, the surface area per unit length of these electrodes was about 200 times as large as the ground contact area per unit length of these electrodes. The surface area and the ground contact area were determined in the same manner as described in Example 4.

As for the counter substrate, a quartz glass was employed and as for the insulating outer frame for separating a pair of substrates from each other, a polyimide plate was employed, thus manufacturing a cell for the light-emitting device.

Thereafter, an electrolyte (which was obtained by dissolving 0.2 g of ruthenium (II) trisbipyridyl (PF₆⁻)₂ in 1.1 g of 1-ethyl-3-methylimidazolium hexafluorodimethylsulfone imide) was then injected into the space between the electrodes. Then, the inlet port for electrolyte was sealed to obtain a light-emitting cell. When an electric current was passed between a pair of facing electrodes at an ac voltage of 3 V, light was emitted at a light volume of 300 cd/m².

### EXAMPLE16

This Example will be explained with reference to FIGS. 47 to 55.

First of all, as shown in FIG. 47, a spacer 43 was sandwiched between a first electrode 41 and a second electrode 42. As for the first electrode 41 and the second electrode 42, a gold foil having a thickness of 50 μm was employed. As for the spacer 43, a PE porous film having a thickness of 20 μm was employed. These electrodes and spacer were pressed to manufacture an electrode sheet 44 as shown in FIG. 48.

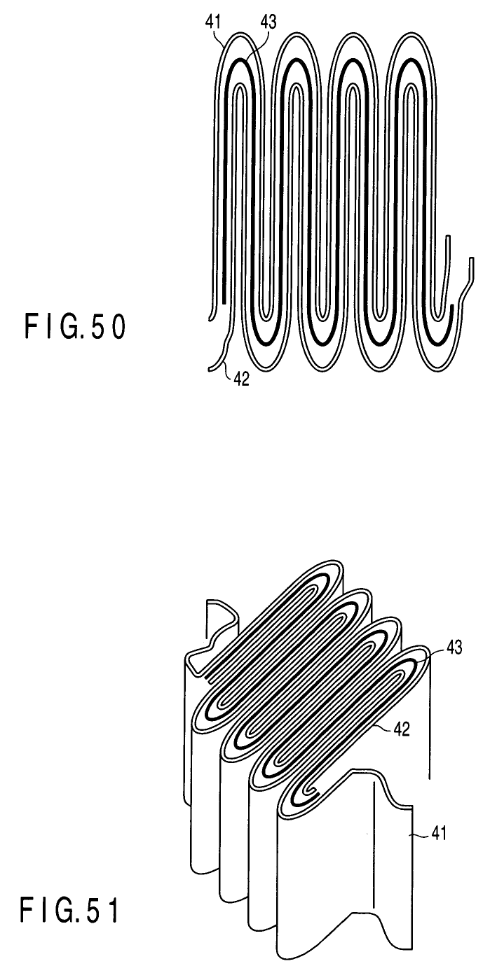

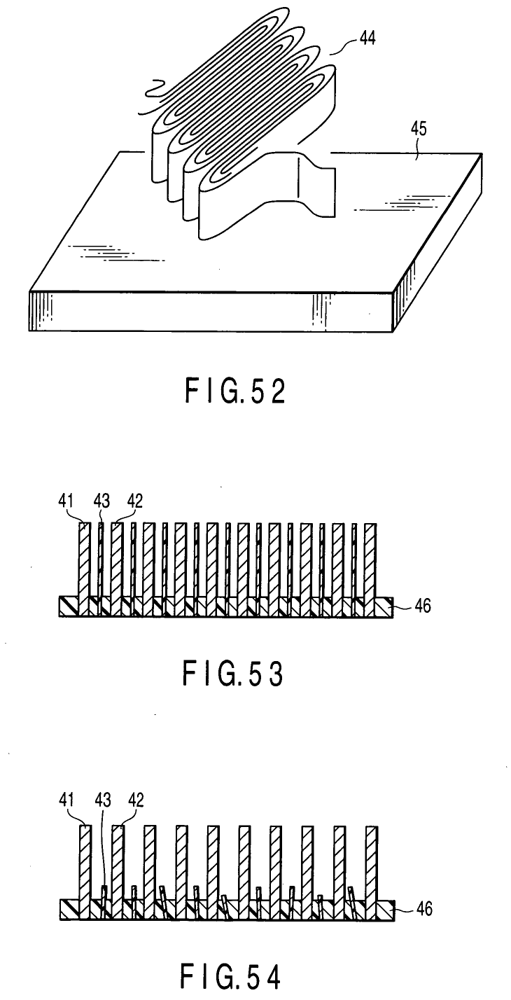

The electrode sheet 44 thus obtained was repeatedly folded back and forth as shown in FIG. 49 and pressed as shown in FIG. 50. FIG. 51 illustrates a perspective view of the electrode sheet 44 after the pressing. One end portion of the electrode group thus obtained was cut off using a diamond cutter and the cut surface thereof was washed and dried. Thereafter, the cut surface was bonded to a substrate 45 as shown in FIG. 52.

Prior to this bonding, one end portion (1 mm in length from the edge) of the electrode group was fixed together by using epoxy resin 46 as shown in detail in FIG. 53. Then, the electrode group was cut off at a portion thereof located 6 mm away from the aforementioned one end portion thereof to obtain an electrode group wherein a pair of electrodes (5 mm in height) 41, 42 with the PE porous film 43 being interposed therebetween were folded back and forth on the epoxy substrate 46 (1 mm in thickness). When the electrodes thus obtained were heated at a temperature of 130° C. for 12 hours, the spacer 43 constituted by a PE porous film was caused to thermally shrink as shown in FIG. 54.

When a partially cut piece of the substrate 1 was microscopically observed, the height of the electrodes 41, 42 thus produced was 5 mm which was about 100 times as large as the width (50 μm) of bottom thereof. Further, the surface area per unit length of these electrodes was about 200 times as large as the ground contact area per unit length of these electrodes. The surface area and the ground contact area were determined in the same manner as described in Example 4.

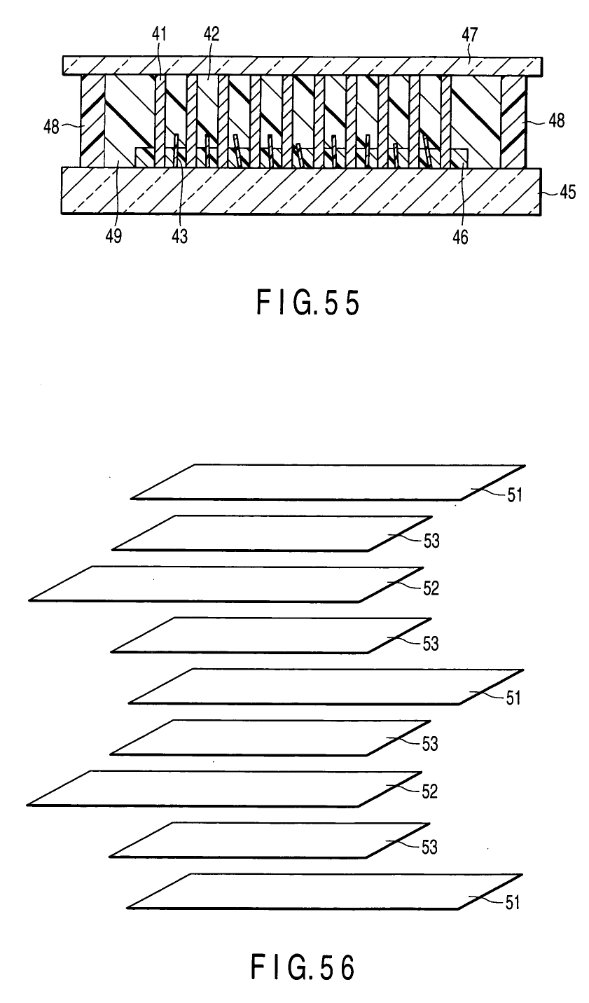

As for the substrate positioned to face the substrate 45, a quartz glass 47 was employed and as for the insulating outer frame for separating a pair of substrates from each other, a polyimide plate was employed, thus manufacturing a cell for the light-emitting device as shown in FIG. 55.

On the other hand, 0.2 g of ruthenium (II) trisbipyridyl (PF₆⁻)₂ was dissolved as an emission pigment in 1.1 g of 1-ethyl-3-methylimidazolium hexafluorodimethylsulfone imide employed as a room temperature molten salt, thereby preparing an electrolyte 49, which was then injected into the space between a pair of substrates 45, 47. Finally, the inlet port for electrolyte was sealed to obtain a light-emitting cell. When an ac voltage of 3 V was applied to a pair of facing electrodes, light was emitted at a light volume of 310 cd/m².

### EXAMPLE17

This Example will be explained with reference to FIGS. 56 to 61.

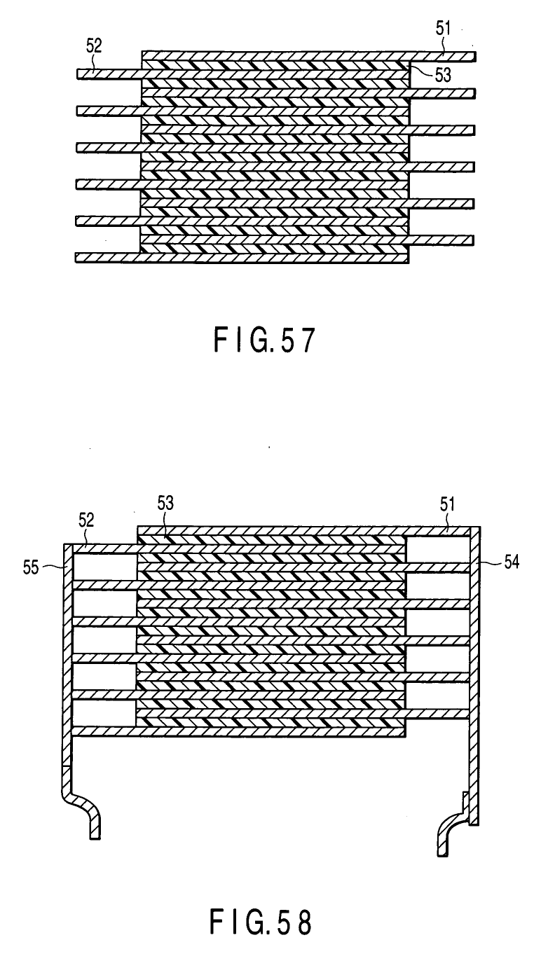

First of all, as shown in FIG. 56, a first electrode 51 and a second electrode 52 were laminated one after another with a porous film 53 being interposed therebetween. As for the first electrode 51 and the second electrode 52, a strip-like gold foil having a thickness of 50 μm was employed as a plate-like electrode material. As for the porous film 53, a PE porous film having a thickness of 20 μm was employed. These first and second electrodes 51, 52 were disposed to off-set from each other and pressed to manufacture an electrode group as shown in FIG. 57.

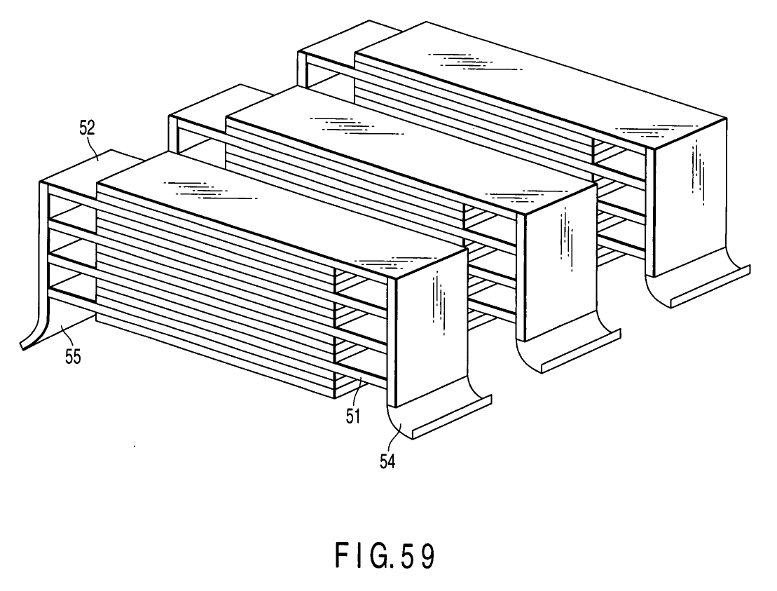

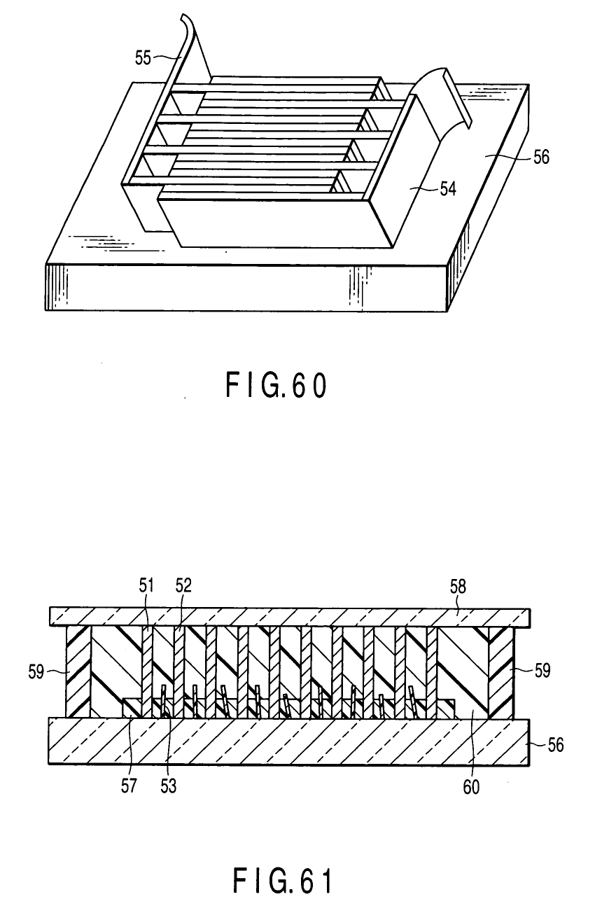

A first electrode group was connected with a first integrated electrode 54 and a second electrode group was connected with a second integrated electrode 55, thus securing electric conductivity as shown in FIG. 58. Then, as shown in FIG. 59, the electrode group was cut off at a portion thereof located 6 mm away from one end portion thereof and the cut surface was washed and dried. Then, one end portion (1 mm in length from the edge) of the electrode group was fixed together by using epoxy resin 57. As a result, it was possible to obtain an electrode group wherein a pair of electrodes (5 mm in height) 51, 52 with the PE porous film 53 being interposed therebetween were successively disposed on the epoxy substrate (1 mm in thickness). When the electrodes thus obtained were heated at a temperature of 130° C. for 12 hours, the PE porous film 53 was caused to thermally shrink, thus manufacturing the electrodes and adhering them to the epoxy substrate 56 as shown in FIG. 60.

When a partially cut piece of the substrate 1 was microscopically observed, the height of the electrodes 51, 52 thus produced was 5 mm which was about 100 times as large as the width (50 μm) of bottom thereof. Further, the surface area per unit length of these electrodes was about 200 times as large as the ground contact area per unit length of these electrodes. The surface area and the ground contact area were determined in the same manner as described in Example 4.

As for the substrate positioned to face the substrate 56, a quartz glass 58 was employed and as for the insulating outer frame for separating a pair of substrates from each other, a polyimide plate was employed, thus manufacturing a cell for the light-emitting device as shown in FIG. 61.

On the other hand, 0.2 g of ruthenium (II) trisbipyridyl (PF₆⁻)₂ was dissolved as an emission pigment in 1.1 g of 1-ethyl-3-methylimidazolium hexafluorodimethylsulfone imide employed as a room temperature molten salt, thereby preparing an electrolyte 60, which was then injected into the space between a pair of substrates 56, 58. Finally, the inlet port for electrolyte was sealed to obtain a light-emitting cell. When an ac voltage of 3 V was applied to a pair of facing electrodes, light was emitted at a light volume of 300 cd/m².

As described above, it is possible, according to the embodiment of the present invention, to provide a light-emitting device exhibiting a high luminance of emission and also to provide a method of manufacturing such a light-emitting device at lower cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light-emitting device comprising:
an insulating substrate;
a first electrode formed above the insulating substrate and having an elongated configuration, in an unit length of the first electrode, a surface area being 3 to 1000 times as large as a ground contact area, the surface area being an area of a surface of the first electrode and the ground contact area being an area projected upon the insulating substrate as the insulating substrate provided with the first electrode is looked from a top surface of the insulating substrate;
a second electrode formed above the insulating substrate, the second electrode being insulated from the first electrode and having an elongated configuration, in an unit length of the second electrode, a surface area being 3 to 1000 times as large as a ground contact area, the surface area being an area of a surface of the second electrode and the ground contact area being an area projected upon the insulating substrate as the insulating substrate provided with the second electrode is looked from a top surface of the insulating substrate; and
an electrolyte disposed on the first electrode and the second electrode and containing an ionic liquid as a major component and luminescent pigment having a reversible redox structure.

2. The light-emitting device according to claim 1, wherein the first electrode and the second electrode are respectively formed of a material selected from the group consisting of gold, platinum, silver, stainless steel and tungsten.

3. The light-emitting device according to claim 1, wherein the ionic liquid is a molten salt having a structure represented by the following general formula (A):

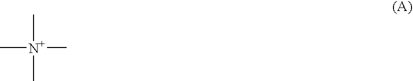

4. The light-emitting device according to claim 1, further comprising a porous layer disposed on at least one of the first electrode and the second electrode while maintaining an insulation between the first electrode and the second electrode.

5. The light-emitting device according to claim 4, wherein the porous layer is formed of semiconductor or conductor.

6. The light-emitting device according to claim 4, wherein the first electrode and the second electrode respectively have a height H which is confined within the range represented by the following expression using a height h of the porous layer.
0.5h<H<10h

7. The light-emitting device according to claim 1, wherein the first electrode and the second electrode are respectively bulky in configuration having a height ranging from 20 μm to 200 μm, and bonded, through the bottoms thereof, to the insulating substrate.

8. The light-emitting device according to claim 7, further comprising a porous layer formed of semiconductor or conductor, and disposed on at least one of the first electrode and the second electrode while maintaining an insulation between the first electrode and the second electrode.

9. The light-emitting device according to claim 8, wherein the first electrode and the second electrode respectively have a height H which is confined within the range represented by the following expression using a height h of the porous layer.
0.5h<H<10h

10. The light-emitting device according to claim 1, wherein the first electrode and the second electrode are respectively bulky in configuration having a height ranging from 0.1 mm to 10 mm and buried in the insulating substrate.

11. The light-emitting device according to claim 10, further comprising a porous layer formed of semiconductor or conductor and disposed on at least one of the first electrode and the second electrode while maintaining an insulation between the first electrode and the second electrode.

12. The light-emitting device according to claim 11, wherein the first electrode and the second electrode respectively have a height H which is confined within the range represented by the following expression using a height h of the porous layer.
0.5h<H<10h

13. The light-emitting device according to claim 1, wherein the first electrode and the second electrode are respectively formed of a porous layer having a height ranging from 1 μm to 20 μm and containing aggregates of fine particles having an average particle diameter ranging from 5 nm to 150 nm.

14. The light-emitting device according to claim 13, further comprising a porous layer formed of semiconductor or conductor and disposed on at least one of the first electrode and the second electrode while maintaining an insulation between the first electrode and the second electrode.

15. The light-emitting device according to claim 14, wherein the first electrode and the second electrode respectively have a height H which is confined within the range represented by the following expression using a height h of the porous layer.
0.5h<H<10h

16. A method for manufacturing a light-emitting device comprising:
forming a laminated or wound composite containing a first electrode and a second electrode with a spacer being interposed therebetween;
forming the first electrode and the second electrode on a first insulating substrate, the first electrode and the second electrode extending in a longitudinal direction and being insulated from each other;
removing the spacer;
positioning a second insulating substrate to face the first insulating substrate with an insulating outer frame being interposed therebetween, thus leaving a space between the second insulating substrate and the first insulating substrate;
injecting an electrolyte containing a molten salt and a colorant into the space through a port; and
sealing the port for the electrolyte.

17. The method according to claim 16, wherein the first electrode and the second electrode are respectively formed of a material selected from the group consisting of gold, platinum, silver, stainless steel and tungsten.

18. The method according to claim 16, wherein the ionic liquid is a molten salt having a structure represented by the following general formula (A):

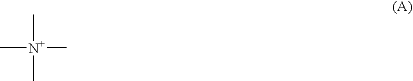

19. The method according to claim 16,. further comprising a porous layer which is disposed on at least one of the first electrode and the second electrode while maintaining an insulation between the first electrode and the second electrode.

20. The method according to claim 19, wherein the porous layer is formed of semiconductor or conductor.
